(19) United States
(12) Patent Application Publication
(10) Pub. No.: US 2024/0381380 A1
(43) Pub. Date: Nov. 14, 2024

(54) METHODS, ARCHITECTURES, APPARATUSES AND SYSTEMS FOR SIDELINK RESOURCE ALLOCATION

(71) Applicant: InterDigital Patent Holdings, Inc., Wilmington, DE (US)

(72) Inventors: Umer Salim, Vallauris (FR); Sanjay Goyal, Deer Park, NY (US); Ashutosh Srivastava, Brooklyn, NY (US); Ravikumar Pragada, Warrington, PA (US)

(21) Appl. No.: 18/686,733

(22) PCT Filed: Aug. 31, 2022
(86) PCT No.: PCT/US2022/042124

§ 371 Date: Feb. 26, 2024

Related U.S. Application Data
(60) Provisional application No. 63/239,493, filed on Sep. 1, 2021.

(51) Int. Cl. H04W 72/25; H04W 16/28; H04W 28/26; H04W 72/40

(52) U.S. Cl. CPC H04W 72/25; H04W 16/28; H04W 28/26; H04W 72/40

(57) ABSTRACT

Procedures, methods, architectures, apparatuses, systems, devices, and computer program products are described that may be implemented in a wireless transmit/receive unit (WTRU) for sidelink (SL) communication. In one representative method, the WTRU estimates a primary direction for a SL transmission. The first WTRU derives a paired direction associated with the primary direction. SL control information (SCI) sensing in the primary and paired directions may be performed to detect SL transmissions and/or reservations from other WTRUs. The WTRU may select a SL resource using any sensed SCI in the primary and paired directions. The WTRU may proceed to transmit SL control and data over the selected SL resource, such as in a SL slot. For example, the transmission of SL control information may include SCI transmission in the primary and paired directions in the same symbols of a slot.

### CROSS-REFERENCE TO RELATED APPLICATIONS

This application claims the benefit of U.S. Provisional Patent Application No. 63/239,493 filed 1 Sep. 2021 which is incorporated herein by reference.

### TECHNICAL FIELD

The present disclosure is generally directed to the fields of communications, software and encoding, including, for example, to methods, architectures, apparatuses, systems directed to sidelink communications.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrative a representative vehicle-to-vehicle (V2V) scenario in which collinear SL communications may occur;

FIG. 3 is a diagram illustrating an example relationship between packet reception ratio (PRR) and periodic traffic intensity for square grid scenarios;

FIG. 4 is a diagram illustrating an example relationship between PRR and periodic traffic intensity for highway scenarios;

FIG. 5 is a diagram illustrating two representative examples of paired transmitter and receiver arrangements;

FIG. 6 is a diagram illustrating another representative example of a paired transmitter and receiver arrangement;

FIG. 7 is a diagram illustrating another two representative examples of paired transmitter and receiver arrangements;

FIG. 8 is a diagram illustrating another representative example of a paired transmitter and receiver arrangement;

FIG. 9 is a diagram illustrating a structure of a SL slot as in Third Generation Partnership Project (3GPP) Rel-16;

FIG. 10 is a diagram illustrating a representative structure of a sidelink (SL) slot for paired SCI;

FIG. 11 is a diagram illustrating another representative structure of a SL slot for paired SCI;

FIG. 12 is a diagram illustrating yet another representative structure of a SL slot for paired SCI;

FIG. 13 is a diagram illustrating representative examples of paired transmitter and receiver arrangements for primary SL control information (SCI) received in a primary direction;

FIG. 14 is a diagram illustrating representative examples of paired transmitter and receiver arrangements for primary SCI received in a paired direction;

FIG. 15 is a diagram illustrating representative examples of paired transmitter and receiver arrangements for paired SCI received in a primary direction;

FIG. 16 is a diagram illustrating representative examples of paired transmitter and receiver arrangements for paired SCI received in a paired direction;

FIG. 17 is a diagram illustrating another example relationship between packet reception ratio (PRR) and periodic traffic intensity for square grid scenarios;

FIG. 18 is a diagram illustrating another example relationship between packet reception ratio (PRR) and periodic traffic intensity for highway scenarios;

FIG. 19 is a diagram illustrating another example relationship between packet reception ratio (PRR) and periodic traffic intensity for square grid scenarios;

FIG. 20 is a diagram illustrating another example relationship between packet reception ratio (PRR) and periodic traffic intensity for highway scenarios;

FIG. 21 is a diagram illustrating another representative structure of a SL slot for paired SCI;

FIG. 22 is a diagram illustrating a representative example of a communication procedure using first and second types of SCI;

FIG. 23 is a diagram illustrating another representative example of a communication procedure using first and second types of SCI;

FIG. 24 is a diagram illustrating another representative example of a communication procedure using first and second types of SCI;

FIG. 25 is a diagram illustrating another representative example of a communication procedure using first and second types of SCI;

FIG. 26 is a diagram illustrating another representative example of a communication procedure using first and second types of SCI;

FIG. 27 is a diagram illustrating another representative example of a communication procedure using first and second types of SCI; and

FIG. 28 is a diagram illustrating another representative example of a communication procedure using first and second types of SCI.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

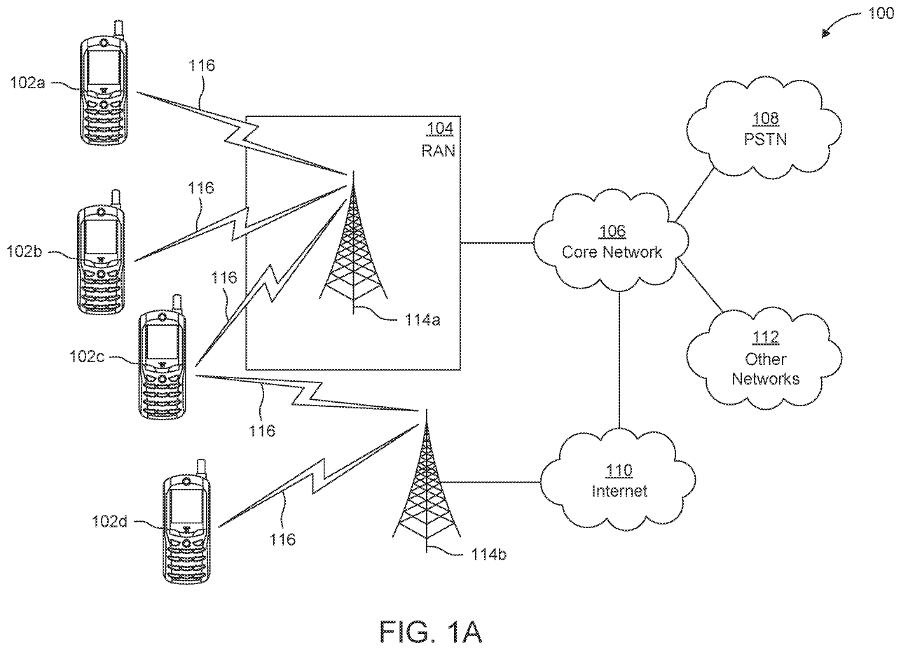

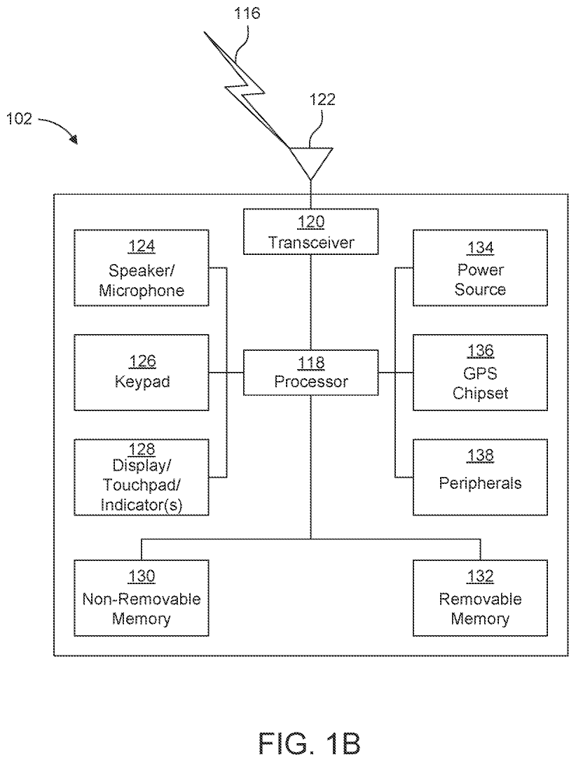

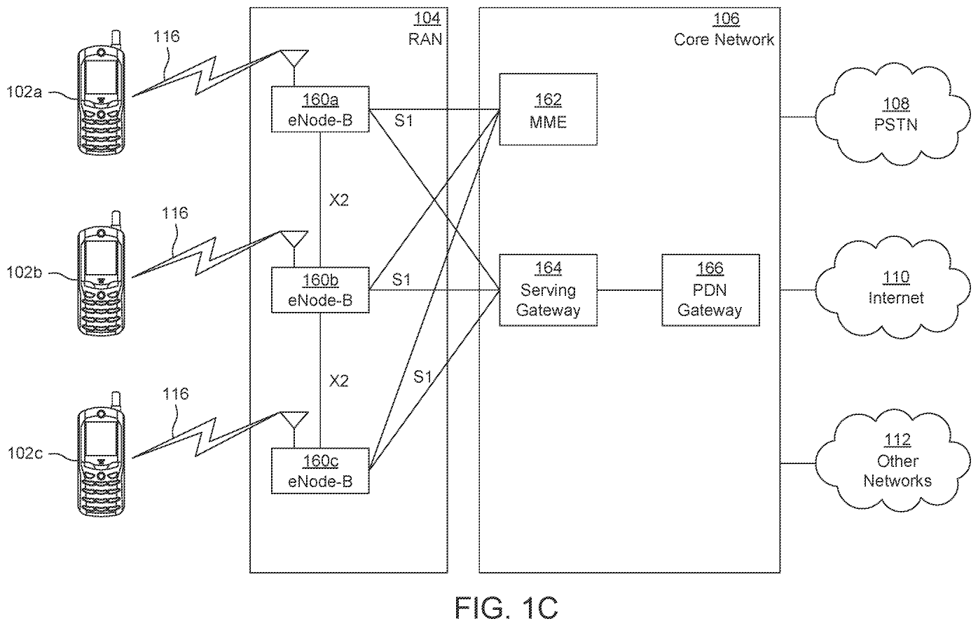

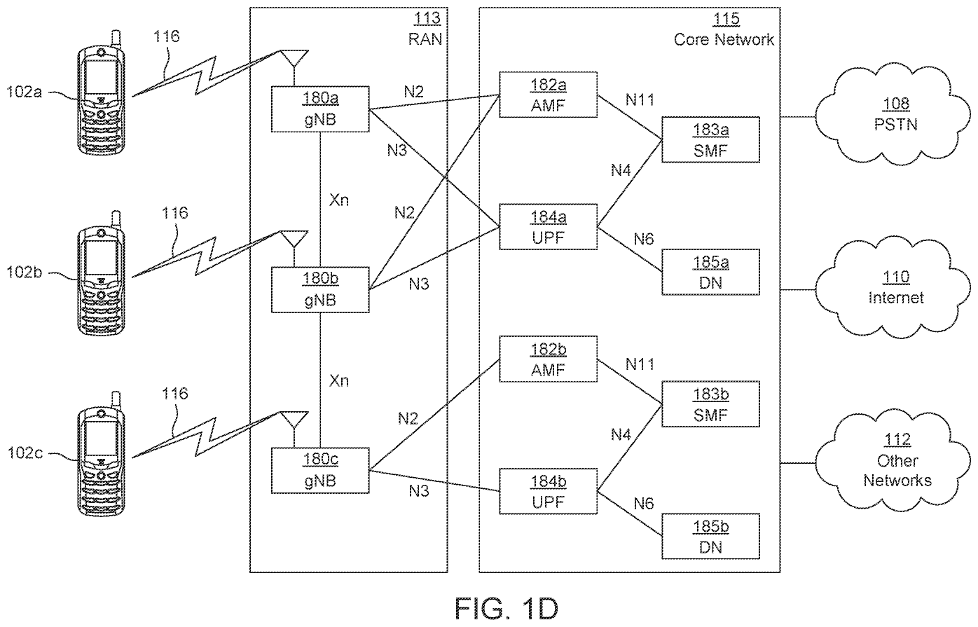

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV white space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations may be used herein:
CG: Configured Grant
CP: Cyclic Prefix
D2D: Device-to-Device
Dir: Directional
DL: Downlink
DM-RS: Demodulation Reference Signals
HARQ: Hybrid Automatic Repeat Request
LTE: Long Term Evolution
MCS: Modulation and Coding Scheme
NR: New Radio
OFDM: Orthogonal Frequency Division Multiplexing
PSCCH: Physical Sidelink Control Channel
PSSCH: Physical Sidelink Data Channel
RB: Resource Block
RRC: Radio Resource Control
RSRP: Received Signal Received Power
RSSI: Received Signal Strength Indicator
Rx: Receiver
SCI: Sidelink Control Information
SL: Sidelink
SPS: Semi-persistent Scheduling
SR: Scheduling Request
SS/PBCH: Synchronization Signal and Physical Broadcast Control Channel Block
S-TMSI: System architecture evolution (SAE)-TMSI
TB: Transmit Block
TDMA: Time Division Multiple Access
T-F: Time-frequency
Tx: Transmitter
UL: Uplink
V2X: Vehicle-to-everything

### Introduction

### D2D Communication

3GPP standardized the first version of D2D communication in Release-12 for proximity services. Later in Release-14, 3GPP standardized LTE V2X based on the 4G LTE cellular standard. Further feature enhancements were developed within 3GPP for Release-15.

In parallel, 3GPP standardized the baseline for the 5G NR cellular standard. 5G NR has been standardized with a very flexible and forward-looking design. It comes with plenty of advanced functionalities like flexible numerologies, advanced design for transmission control, bandwidth parts, configurability of transmissions, HARQ related parameters etc. The standardization SL communications by 3GPP occurred in Release-16, also referred to as NR SL, which has been designed with the NR foundations. SL as used herein may refer to (e.g., direct) data communication between devices without data passing through the network. Resource allocation for SL though has different techniques which enable efficient sidelink operation for devices which are in-coverage of a cell and/or out of coverage.

### NR SL in Release 16

3GPP technical report (TR) 22.886 and technical standard (TS) 22.186 present a description of NR V2X use cases and requirements, respectively which become the basis for NR SL work in Rel-16. Use cases may be divided in the following four groups:

1) Vehicle Platooning: This group includes use cases for the dynamic formation and management of groups of vehicles in platoons. Vehicles in a platoon may exchange data periodically to facilitate the correct functioning of the platoon. An inter-vehicle distance between vehicles in a platoon may depend on the available QoS.

2) Advanced Driving: This group includes use cases for enabling semi-automated or fully-automated driving. In this group, vehicles may share data obtained from their local sensors with vehicles in the surrounding proximity. In addition, the vehicles may share their driving intentions in order to coordinate their trajectories or maneuvers, which may lead to increasing safety and/or improving traffic efficiency.

3) Extended Sensors: This group enables the exchange of sensor data-either raw or processed-which may be collected through local sensors between vehicles, RSUs, devices of pedestrians, and V2X application servers. The objective is to improve the perception of the environment beyond the perception capabilities of the vehicles' own sensors.

4) Remote Driving: This group enables a remote (e.g., tele-operated) driver or a V2X application to operate a vehicle. The main use cases are for passengers who cannot drive themselves, for vehicles located in hazardous environments (e.g., construction areas or locations with adverse weather conditions), and for complex situations in which automated vehicles may be unable to drive safely.

The physical layer structure for the NR V2X SL is based on the Rel.-15 NR Uu design. In addition, the physical layer procedures for the NR V2X SL reuse some of the concepts of Rel.-14 LTE V2X, with the introduction of additional procedures for providing physical layer support for unicast and groupcast transmissions. Although both frequency ranges are supported in NR V2X sidelink, the design of NR V2X sidelink has been based mainly on FR1. For NR V2X sidelink, no specific optimization is performed for FR2 other than for addressing phase noise which may be more prominent at higher frequencies.

Transmissions in NR V2X SL use the orthogonal frequency division multiplexing (OFDM) waveform with a cyclic prefix (CP). The sidelink frame structure is organized in radio frames (also referred to as frames), each with a duration of 10 ms. A radio frame is divided into 10 subframes, each with a duration of 1 ms. This physical structure is basically aligned with the 5G NR Uu structure which was standardized in Rel.-15.

### SL Resource Allocation

3GPP Rel.-16 provides two designs for SL resource allocation. For the devices in-coverage of a cell, SL resource allocation is performed by the gNB 180, which is called Mode 1 resource allocation. SL devices may perform autonomous resource allocation based upon sensing the resources themselves which have been made available for sidelink communication. This autonomous mode of sidelink resource allocation is called Mode 2 resource allocation. Autonomous resource allocation and Mode 2 resource allocation may be used interchangeably herein. A device (e.g., an SL device) may perform operations on condition that it is operating according to Mode 1 (e.g., after receiving a SL resource allocation from the network) or Mode 2 (e.g., after SL resource sensing of available resources).

### Resource Allocation-Mode 1

The gNB 180 performs the SL resource allocation in Mode 1. Thus, the devices operating under a Mode 1 resource allocation must be in network coverage. SL radio resources can be allocated from licensed carriers dedicated to SL communications or from licensed carriers that share resources between SL and UL communications. The SL radio resources may be configured so that mode 1 and mode 2 use separate resource pools. One alternative is that mode 1 and mode 2 share the resource pool. Pool sharing can result in a more efficient use of the resources, but it is prone to potential collisions between mode 1 and mode 2 transmissions. Mode 1 UEs may notify mode 2 UEs of the resources allocated for their future transmissions.

Mode 1 uses dynamic grant (DG) scheduling like LTE V2X mode 3 but replaces the semi-persistent scheduling in LTE V2X mode 3 with a configured grant scheduling. With DG, mode 1 UEs must request resources to the base station for the transmission of every single TB (and possible blind or HARQ retransmissions). To this aim, the UEs must send a Scheduling Request (SR) to the gNB 180.

Requesting resources for each TB increases the delay. Mode 1 includes the configured grant scheduling option to reduce the delay by pre-allocating SL radio resources. With this scheme, the gNB 180 can assign a set of SL resources to a UE for transmitting several TBs. This set of SL resources is referred to as a configured grant (CG). Mode 1 defines two types of CG schemes for SL: CG type 1 and CG type 2. Both are configured using Radio Resource Control (RRC) signaling. CG type 1 may be utilized by the UE immediately until it is released by the base station (e.g., also using RRC signaling). SL CG type 2 may be used only after it is activated by the gNB 180 and until it is deactivated.

### Resource Allocation-Mode 2

In SL resource allocation Mode 2, SL devices may autonomously select their SL resources from a resource pool. In some cases, SL devices may operate without network coverage. The resource pool may be (pre-) configured by a base station (e.g., the gNB 180 or eNB) when the UE is in network coverage. Mode 2 allocation may be performed using a dynamic or a semi-persistent scheduling scheme. SL Devices may also reserve future resources which may be indicated through sidelink control information (SCI). A reserved resource may refer to a selected resource that a UE reserves for a future transmission by notifying neighboring WTRUs 102 using SCI (e.g., 1st-stage SCI). As would be understood by a person of skill in the art, in two-stage SCI procedure in 5G NR V2X, a 1st-stage SCI is carried on by a PSCCH transmission while the subsequent 2nd-stage SCI is carried on a corresponding PSSCH transmission. A UE may select and reserve resources for the transmission of several TBs (and their retransmissions) when utilizing a semi-persistent scheme. The semi-persistent scheme may be enabled or disabled in a resource pool by (pre-) configuration. As a brief description for Mode 2 resource allocation, an example procedure can be defined as a two-step process of resource identification and resource selection.

Resource Identification Step: A SL device may decide a suitable time zone to transmit a packet (e.g., depending upon its delay budget). The time zone may be referred to as a resource selection window. The SL device will then perform sensing in the previous time slots, which may be jointly referred to as a sensing window. Any slots which include indications of future reservations or periodic transmissions will be removed if the detected SCIs are estimated to have a reference symbol received power (RSRP) larger than configured thresholds. The thresholds may depend upon the priority of the detected transmission and the priority of the intended transmission. For example, when remaining resources in the resource selection window are less than 20%, the RSRP thresholds may increased by 3 dB and the process may be repeated.

Resource Selection Step: From among the identified candidate resources in the resource identification step, the SL device may choose a potential SL Tx resource randomly. The random selection may lead to interference randomization and/or may avoid the scenario where neighboring devices are selecting the same resource for transmission.

The detailed procedure for Mode 2 resource allocation is given in [4], which is reproduced in the following subsection.

### Procedure for Determining a Subset of Resources to be Reported in Pssch Resource Selection in SL Resource Allocation Mode 2

In Rel.-16, TS 38.214 describes procedures for resource allocations according to Mode 2. In Mode 2, a higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot,
L_{subCH};
optionally, the resource reservation interval, P_{rsvp_TX}, in units of msec.
if the higher layer requests the UE to determine a subset of resources from which the higher layer will select resources for PSSCH/PSCCH transmission as part of re-evaluation or pre-emption procedure, the higher layer provides a set of resources (r₀, r₁, r₂, . . . ) which may be subject to re-evaluation and a set of resources (r₀′, r₁∝, r₂′, . . . ) which may be subject to pre-emption.
   it is up to UE implementation to determine the subset of resources as requested by higher layers before or after the slot r″ᵢ-T₃, where r″ᵢ is the slot with the smallest slot index among (r₀, r₁, r₂, . . . ) and (r₀′, r₁′, r₂′, . . . ), and T₃ is equal to T_{proc,1}^{SL}, where T_{proc, 1}^{SL} is defined in slots in Table 8.1.4-2 where μ_{SL} is the SCS configuration of the SL BWP.
      The following higher layer parameters affect this procedure:
sl-SelectionWindowList: internal parameter T₂ₘᵢₙ is set to the corresponding value from higher layer parameter sl-SelectionWindowList for the given value of prio_{TX}.
sl-ThresPSSCH-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ=prio_{TX}.
sl-RS-ForSensing selects if the UE uses the PSSCH-RSRP or PSCCH-RSRP measurement, as defined in clause 8.4.2.1.
sl-ResourceReservePeriodList
sl-SensingWindow: internal parameter T₀ is defined as the number of slots corresponding to sl-SensingWindow msec
sl-TxPercentageList: internal parameter X for a given prio_{TX} is defined as sl-TxPercentageList (prio_{TX}) converted from percentage to ratio
sl-PreemptionEnable: if sl-PreemptionEnable is provided, and if it is not equal to ‘enabled’, internal parameter prioₚᵣₑ is set to the higher layer provided parameter sl-PreemptionEnable
   The resource reservation interval, P_{rsvp_TX}, if provided, is converted from units of msec to units of logical slots, resulting in P′_{rsvp_Tx} according to clause 8.1.7.

### Notation:

(t′₀^{SL}, t′₁^{SL}, t′₂^{SL}, . . . ) denotes the set of slots which belongs to the sidelink resource pool and is defined in Clause 8.

The following steps are used:

1) A candidate single-slot resource for transmission R_{x,y} is defined as a set of L_{subCH} contiguous sub-channels with sub-channel x+j in slot t′_{y}^{SL} where j=0, . . . , L_{subCH}−1. The UE shall assume that any set of L_{subCH} contiguous sub-channels included in the corresponding resource pool within the time interval [n+T₁, n+T₂] correspond to one candidate single-slot resource, where
selection of T₁ is up to UE implementation under 0≤T₁≤ T_{proc,1}^{SL}, where T_{proc,1}^{SL} is defined in slots in Table 8.1.4-2 where μ_{SL} is the SCS configuration of the SL BWP;
if T₂ₘᵢₙ is shorter than the remaining packet delay budget (in slots) then T₂ is up to UE implementation subject to T₂ₘᵢₙ≤T₂≤ remaining packet budget (in slots); otherwise T₂ is set to the remaining packet delay budget (in slots).
The total number of candidate single-slot resources is denoted by Mₜₒₜₐₗ.

2) The sensing window is defined by the range of slots [n-T₀, n-T_{proc,0}^{SL}) where T₀ is defined above and T_{proc,0}^{SL} is defined in slots in Table 8.1.4-1 where μ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.

3) The internal parameter Th(pᵢ, pⱼ) is set to the corresponding value of RSRP threshold indicated by the i-th field in sl-ThresPSSCH-RSRP-List, where i=pᵢ+ (pⱼ−1)*8.

4) The set S_{A} is initialized to the set of all the candidate single-slot resources.

5) The UE shall exclude any candidate single-slot resource R_{x,y} from the set S_{A} if it meets all the following conditions:
the UE has not monitored slot t′ₘ^{SL} m in Step 2.
for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, condition c in step 6 would be met.

6) The UE shall exclude any candidate single-slot resource R_{x,y} from the set S_{A} if it meets all the following conditions:
a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{Rx}, respectively according to Clause 16.4 in [6];
b) the RSRP measurement performed, according to clause 8.4.2.1 for the received SCI format 1-A, is higher than Th(prio_{Rx}, prio_{TX});
c) the SCI format received in slot t′ₘ^{SL} or the same SCI format which, if and only if the ‘Resource reservation period’ field is present in the received SCI format 1-A, is assumed to be received in slot(s) t′_{m+P′}_{_{rsvp_RX}}^{SL} determines according to clause 8.1.5 the set of resource blocks and slots which overlaps with R_{x,y+j×P′}_{_{rsvp_TX}} for q=1, 2, . . . , Q and j=0, 1, . . . , Cᵣₑₛₑₗ−1. Here, P′_{rsvp_RX} is P_{rsvp_RX} converted to units of logical slots according to clause 8.1.7,

$$Q = ⌈ \frac{{T}_{scal}}{{P}_{rsvp \_ RX}} ⌉$$

if P_{rsvp_RX}<T_{scal} and n′−m≤P′_{rsvp_RX},
where t′_{n′}^{SL}=n if slot n belongs to the set (t′₀^{SL}, t′₁^{SL}, . . . , t′_{T′}_{ₘₐₓ}₋₁^{SL}), otherwise slot t′_{N′}^{SL} is the first slot after slot n belonging to the set (t′₀^{SL}, t′₁^{SL}, . . . , t′_{T′}_{ₘₐₓ}₋₁^{SL}); otherwise Q=1.
T_{scal} is set to selection window size T₂ converted to units of msec.

7) If the number of candidate single-slot resources remaining in the set S_{A} is smaller than X. Mₜₒₜₐₗ, then Th(pᵢ, pⱼ) is increased by 3 dB for each priority value Th(pᵢ, pⱼ) and the procedure continues with step 4.

The UE shall report set S_{A} to higher layers.

If a resource rᵢ from the set (r₀, r₁, r₂, . . . ) is not a member of S_{A}, then the UE shall report re-evaluation of the resource rᵢ to higher layers.

If a resource r′ᵢ from the set (r′₀, r′₁, r′₂, . . . ) meets the conditions below then the UE shall report pre-emption of the resource r′ᵢ to higher layers
r′ᵢ is not a member of S_{A}, and
r′ᵢ meets the conditions for exclusion in step 6, with Th(prio_{Rx}, prio_{TX}) set to the final threshold after executing steps 1)-7), i.e. including all necessary increments for reaching X·Mₜₒₜₐₗ, and
the associated priority prio_{Rx}, satisfies one of the following conditions:
   sl-PreemptionEnable is provided and is equal to ‘enabled’ and prio_{TX}>prio_{Rx}
   sl-PreemptionEnable is provided and is not equal to ‘enabled’, and prio_{Rx}<prioₚᵣₑ and prio_{TX}>prio_{Rx}

TABLE 8.1.4-1
T_{proc, 0}^{SL} depending on sub-carrier spacing

| μ_{SL} | T_{proc, 0}^{SL} [slots] |
|---|---|
| 0 | 1 |
| 1 | 1 |
| 2 | 2 |
| 3 | 4 |

TABLE 8.1.4-2
T_{proc, 1}^{SL} depending on sub-carrier spacing

| μ_{SL} | T_{proc, 1}^{SL} [slots] |
|---|---|
| 0 | 3 |
| 1 | 5 |
| 2 | 9 |
| 3 | 17 |

For very high frequency carriers, omni-directional transmission and reception may not be practical due to significant propagation loss and it may result in significant coverage loss. Larger antenna arrays may be used to increase antenna gain to form high gain directional transmissions and receptions. If legacy designed autonomous resource allocation procedures are projected to very high frequency carriers, the strong directionality associated to Tx and Rx beams may result in significant performance degradation and many of the procedures do not perform in a satisfactory manner. In certain use cases, autonomous resource allocation may be performed in highly directional sidelink systems. If a potential transmitter performs sensing for resource allocation in an intended direction of transmission alone, it may not detect ongoing transmissions among the neighboring devices which are not aligned to with the intended transmission direction. This may result in a collision and one or both of the transmissions may be at risk of erroneous reception. On the other hand, if a potential transmitter can perform sensing for resource allocation in an omni-directional manner, it will detect the transmissions around it from all directions, even transmissions which may not result in degradation due to directionality. Performance degradation may occur in certain scenarios due to exposed node issues (e.g., when a node senses resources are busy due to a transmission from another node and is prevented from transmission though the transmission from the other node may not cause a collision). For example, the exposed node issue may be the result of sensing in broader directions than what is to be used target transmission and taking into account the transmissions detected from these broader directions during the resource allocation procedure.

Efficient sensing-based resource allocation strategies may be implemented for high frequency systems in order to take into account the directional nature of transmission and reception beams.

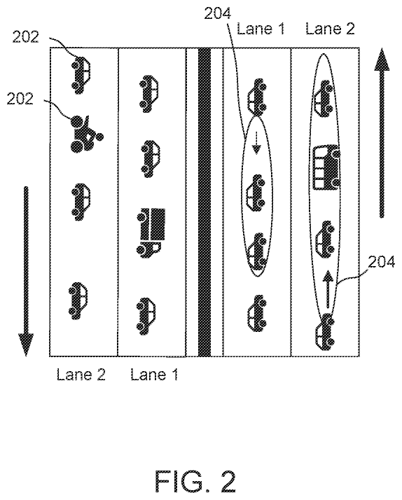

In highly directional systems which operate over very high carrier frequencies (e.g., mmWave and higher), issues may arise when communicating pairs of devices are (e.g., almost) collinear. For example, such directional issues may arise with carrier frequencies of around 6 GHz and may become more prevalent for higher frequencies. With vehicles on roads and highways, collinear scenarios are typical. FIG. 2 is a system diagram illustrative a representative V2V scenario in which collinear SL communications may occur. In FIG. 2, vehicles 202 may be assumed, for simplicity, to be travelling on a two-lane highway in two directions. As those skilled in the art should understand, collinear transmission and/or reception 204 among the devices may be more prevalent among the vehicles communicating on the sidelink, as compared to the cellular Uu interface where all the mobile devices talk to a central base station (e.g., gNB 180). In certain representative embodiments, procedures for efficient autonomous sidelink resource allocation may alleviate collisions in such scenarios.

### Square Grid Scenario Simulation

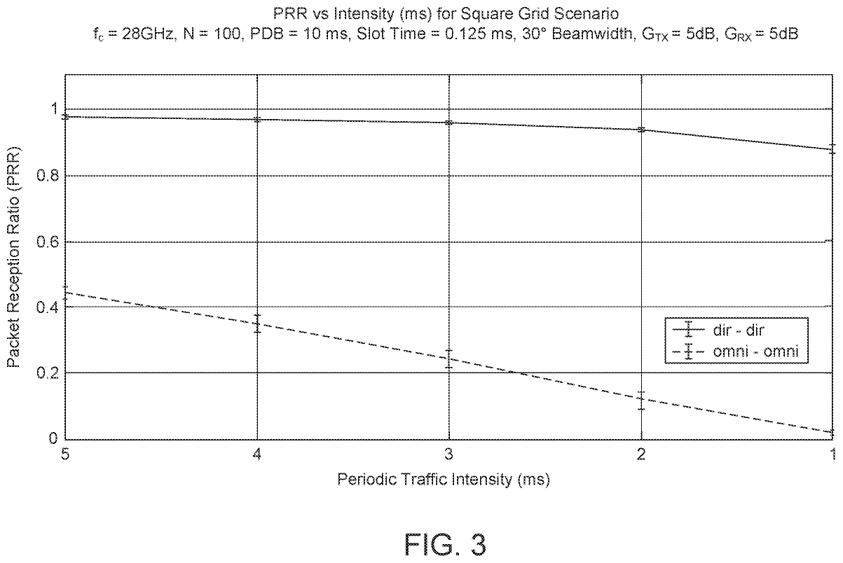

FIG. 3 is a diagram illustrating a relationship between packet reception ratio (PRR) and periodic traffic intensity (also referred to as traffic arrival rate) for square grid systems. In FIG. 3, the performance is shown for omnidirectional and directional SCI transmission and sensing with increasing traffic intensity. The details on the system setup for the simulations and the parameter settings are described later.

As shown in FIG. 3, where SCI sensing and SCI (e.g., 1^{st} stage SCI) transmission are performed in omnidirectional fashion (e.g., an omnidirectional-to-omnidirectional system represented as omni-omni in the FIG. 3), interference reception from all directions can lead to many packet failures as the periodic traffic intensity increases up to 1 ms. where 1^{st} stage SCI transmission and sensing are performed in a directional fashion (e.g., a directional-to-directional system, represented as dir-dir in the FIG. 3), the performance is significantly better than that of the omni-directional systems. In this scheme, a transmitter will perform sensing toward its target transmit direction only and a receiver will receive data from its intended transmitter direction only. Nevertheless, this performance may still fall short of QoS requirements. As an example, for the square grid scenario with 1 ms periodic traffic intensity, the average PRR for the “omni-omni” system has decreased to 2.1% whereas the average PRR for the “dir-dir” system at the same traffic intensity is 87.8%.

### Highway Scenario Simulation

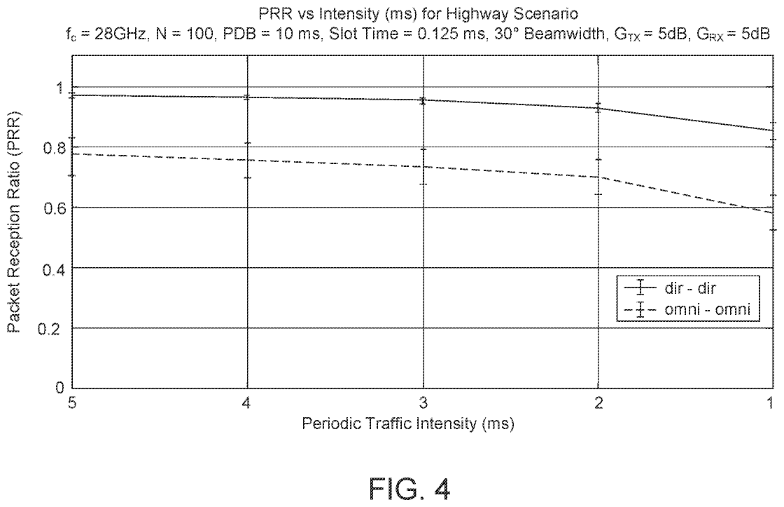

FIG. 4 is a diagram illustrating a relationship between packet reception ratio (PRR) and periodic traffic intensity for highway scenarios (e.g., collinear scenarios). In FIG. 4, the performance is shown for omnidirectional and directional SCI sensing and SCI transmission with increasing traffic intensity. For vehicular communication, highway scenarios may be more relevant and/or more typical as compared to square grid scenarios. As shown in FIG. 4, the omni-directional system (represented as omni-omni in the FIG. 4) performs very poorly at higher traffic intensities with a PRR of 58% at a traffic intensity of 1 ms whereas the average PRR of the “dir-dir” system is 85.3%.

FIGS. 3 and 4 demonstrate that autonomous sidelink operation may not have satisfactory performance to meet the demands for upcoming applications. As an example, if the packet reception ratio requirement is 90%, both omni-directional and directional schemes may fail to ensure the required QoS at higher traffic intensity in the highway scenarios. In general, applications and systems tend to evolve towards ever higher traffic. This may be even more true for the future applications envisaged for sidelink based systems. A need exists for enhanced solutions for SL resource allocation (e.g., in the autonomous mode) in order to provide QoS metrics at acceptable levels.

### Overview—SCI Transmission and Associated Sensing Techniques

For highly directional systems, collinear transmissions may be detrimental from a collision perspective and need to be considered while performing sensing for SL autonomous resource allocation. To address such issues in directional SL systems, enhancements for SL autonomous resource allocation are described herein based upon procedures for SCI transmission and (e.g., autonomous) resource allocation for SL resources which are suitable for highly directional systems operating at very high carrier frequencies.

SCI Transmission with Primary Direction (0°) and Opposite Paired Direction (180°)

In certain representative embodiments, a SL transmission is transmitted over a SL where the SL transmission (e.g., SCI) is transmitted in an intended direction of transmission (e.g., 0° transmission) and also (e.g., subsequently) transmitted in the direction opposite to the intended direction of transmission (e.g., 180° transmission). For example, the intended direction of transmission may be referred to herein as any of a first direction, a first beam direction, and/or a primary direction. For example, a first beam direction may be associated to or with a first antenna panel, and/or may refer to the transmission and/or reception through the first antenna panel (e.g., with or without application of specific weights and/or phases to the antenna elements forming the antenna panel). For example, an antenna panel may refer to an antenna panel radiation pattern or an antenna panel directional radiation pattern with suitable application of weights and/or phases to direct the transmission to and/or reception from an intended direction of transmission. A “paired direction” may refer herein to a direction opposite to the intended direction of transmission. For example, the paired direction of transmission may be referred to herein as any of a second direction, a second beam direction, and/or a secondary direction. For example, a second beam direction may be associated to or with a second antenna panel, and/or may refer to the transmission and/or reception through the second antenna panel (e.g., with or without application of specific weights and/or phases to the antenna elements forming the antenna panel). For example, the second antenna panel may refer to an antenna panel radiation pattern or an antenna panel directional radiation pattern with suitable application of weights and/or phases to direct the transmission to and/or reception from a paired direction. The two transmissions may occur in a sequence, such as where the SL device uses an antenna panel or a set of antennas in a different direction for the two transmissions. SCI transmission in the paired direction, in addition to the intended transmission direction, for autonomous resource allocation will achieve technical advantages which will become apparent to those skilled in the art. As used herein, the terms direction, beam direction, antenna panel, antenna, and/or radiation pattern may be used interchangeably.

SCI Sensing with Primary Direction (0°) and Opposite Paired Direction (180°)

In certain representative embodiments, the sensing of SCI (e.g., for resource allocation purposes) may be neither omni-directional (e.g., as in legacy SL designs) nor only in the intended direction of transmission. For example, a potential transmitter may perform SCI sensing (e.g., for autonomous resource allocation) in (i) an intended direction of transmission, and (ii) a direction paired to the intended direction of transmission. The SL device performing sensing may know (e.g., be configured to determine) the sequence for primary and paired SCI transmissions, and may adapt its receive beams accordingly. SL devices are assumed to be capable of performing sensing in primary and paired directions simultaneously.

When a SL device is performing sensing (e.g., for autonomous resource allocation) for its upcoming SL transmission in the intended transmission direction and in the paired direction, the SL device is sensing the majority of transmissions with which its own transmissions may be at risk of collision.

### SCI Sensing in Paired Direction

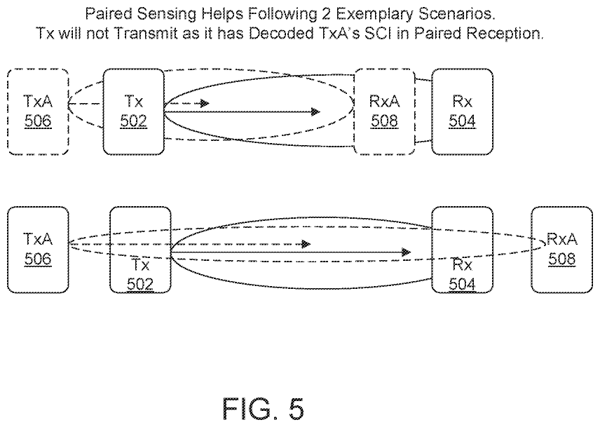

FIG. 5 is a diagram illustrating two examples of paired transmitter and receiver arrangements. In FIG. 5 and the following FIGS., “Tx” designates a target transmitter SL device 502 (e.g., a WTRU 102) and “Rx” designates a target receiver SL device 504 (e.g., a second WTRU 102). The Tx 502 may perform SL sensing in the intended direction and the paired direction (e.g., for SL autonomous resource allocation). “TxA” designates another transmitter SL device 506 (e.g., a third WTRU 102) and “RxA” designates another receiver SL device (e.g., a fourth WTRU 102). TxA 506 and RxA 508 form an SL pair which are in communication where TxA 506 transmits data toward RxA 508. In both examples in FIG. 5, TxA 506 is located to the left hand side of Tx 502, while the relative position of Rx 504 and RxA 508 are changed in the examples.

For example, if the Tx 502 were to perform sensing in the intended direction of transmission alone (e.g., toward its intended receiver Rx 504), the Tx 502 will not be able to detect a reservation and/or transmission from TxA 506. The intended receiver Rx 504 will receive the transmission from TxA 506 as it is aligned with the transmission direction of TxA 506. With the sensing only in the intended direction of transmission, the Tx 502 will not detect the reservation and/or transmission from TxA 506. This may result in the Tx 502 selecting the same time and frequency resources resulting in a collision and an interference situation at both of the receivers Rx 504 and RxA 508. This scenario may be avoided if the Rx 504 transmits some form of feedback and/or takes part in a sensing process providing some information to the Tx 502.

For example, the Tx 502 performs sensing in the paired direction and also performs sensing in the primary (e.g., intended) direction. Doing so, the Tx 502 may detect the reservation and/or transmission from TxA 506. The Tx 502 may proceed to remove the SL resource(s) used and/or reserved by TxA 506 from the candidate list of SL resources at the Tx 502. The removal by the Tx 502 may depend upon an estimated SNR for TxA 506 transmission and/or thresholds for resource allocation. The Tx 502 may proceed to not transmit based on decoding SCI from TxA 506 in the paired direction. The Tx 502 may proceed to transmit using SL resources other than the SL resources which are sensed from TxA 506.

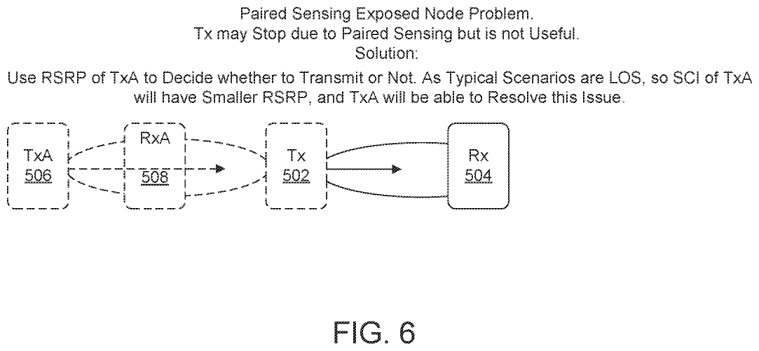

FIG. 6 is a diagram illustrating another example of a paired transmitter and receiver arrangement. In FIG. 6, if paired sensing is not properly applied, the paired sensing can lead to an exposed node issue. For example, the Tx 502 is performing sensing (e.g., for autonomous resource allocation) for its transmission to its intended receiver Rx 504. Another pair of TxA 506 and RxA 508 are assumed to already be in communication with each other and the TxA 506 may indicate a reservation for a given time frequency resource (e.g., by transmitting SCI). In FIG. 6, the Tx 502 may perform sensing in the paired direction to decode a reservation from the TxA 506. This may lead to an exposed node situation where TxA 506 transmission (e.g., SL reservation and/or transmission) will reach the intended Rx 508 with minimal power. The exposed node situation is an example situation where a device is being exposed to an interfering signal, and may avoid this resource considering collision risk, but in reality, this exposition will not be harmful for its transmission. The Tx 502 may be able to estimate the impact of TxA's transmission at the intended receiver Rx 504 based upon some knowledge of Rx's direction and/or location. The Tx 502 may determine that the detected reservation from TxA 506 is not harmful for its transmission (e.g., the transmission from the Tx 502) intended for Rx 504 and/or may determine that its transmission (e.g., the transmission from the Tx 502) will not negatively impact reception at RxA 508, and the Tx 502 may not remove the detected resource from its candidate list of SL resources. In certain representative embodiments, one or more thresholds may be used in conjunction with TxA's estimated power (e.g., with respect to Rx's location) to avoid an exposed node situation. For example, on condition that the Tx 502 determined the TxA's estimated power is less than or equal to a first threshold and that the Rx's position is greater than or equal to a second threshold, the Tx 502 may use the SL resource associated with the TxA's reservation and/or transmission. As another example, on condition that the Tx 502 determined the TxA's estimated power at the Rx's location, is less than or equal to a threshold, the Tx 502 may use the SL resource associated with the TxA's reservation and/or transmission. Otherwise, for example, the Tx 502 may remove the SL resource from the candidate list of SL resources.

### Impact of SCI Transmission in Paired Direction

In certain representative embodiments, SCI transmission in the paired direction (e.g., paired SCI) may improve the sensing for directional systems. In some examples, this may potentially lead to exposed node situations.

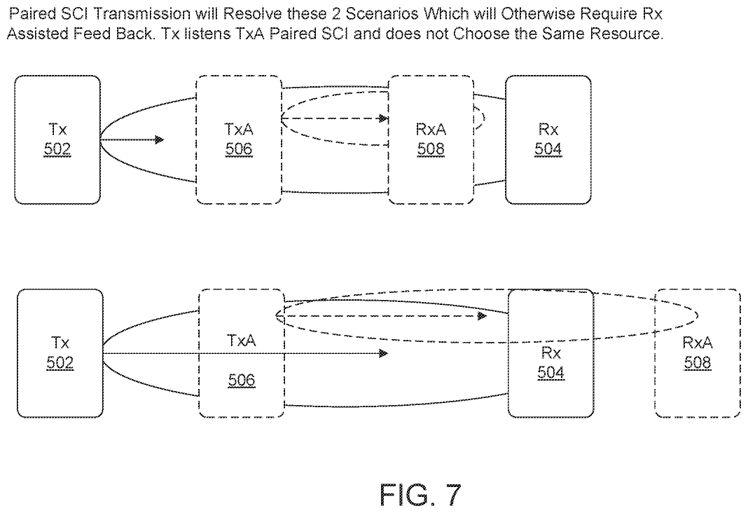

FIG. 7 is a diagram illustrating another two examples of paired transmitter and receiver arrangements in which there are two collinear placements for two pairs of SL devices. In FIG. 7, TxA 506 is transmitting to RxA 508 and has indicated a reservation for a future time frequency resource (e.g., SL resource). Tx 502 is performing sensing (e.g., for autonomous resource allocation) to transmit to its intended receiver Rx 504. In a legacy system, the TxA 506 will (e.g., only) transmit its SCI in the intended direction of transmission toward RxA 508, and Tx 502 will not receive and decode that reservation. If the resource selection procedure used at Tx 502 chooses the same time frequency resource as indicated by TxA 506, the two transmissions will collide at the two receivers and may lead to detection errors. While it may be possible to avoid such situations by implementing receiver coordination with the transmitter, this comes at the cost of delays and additional signaling.

In certain representative embodiments, a SL transmitter may transmit SCI in the primary and the paired direction. For example, TxA 506 may transmit SCI in a primary direction (e.g., toward its intended receiver RxA) and in a paired direction (e.g., 180′ opposite to the intended direction). While the Tx 502 may not receive the energy transmitted by TxA 506 in the primary direction, the Tx 502 may receive SCI from TxA 506 transmitted in the paired direction. The decoding of paired SCI (e.g., SCI transmitted in the paired direction) at the Tx 502 which was transmitted by the TxA 506 may indicate to the Tx 502 that a time frequency resource (e.g., SL resource) is reserved by TxA 506. The Tx 502 can associate the reserved resource in use by TxA 506 with the RSRP estimated while decoding the paired SCI. for example, the paired SCI transmission by the TxA 506 may allow the Tx 502 to avoid a scenario where the TxA 506 may otherwise cause a hidden node situation and/or require receiver feedback. It should also be appreciated that the hidden node situation in this case may not be resolved by having any kind of directional or omni-directional sensing at the target transmitter Tx 502. Due to the SCI transmission in the paired direction from TxA 506, the Tx 502 may receive, decode and process the reservation transmitted by TxA 506.

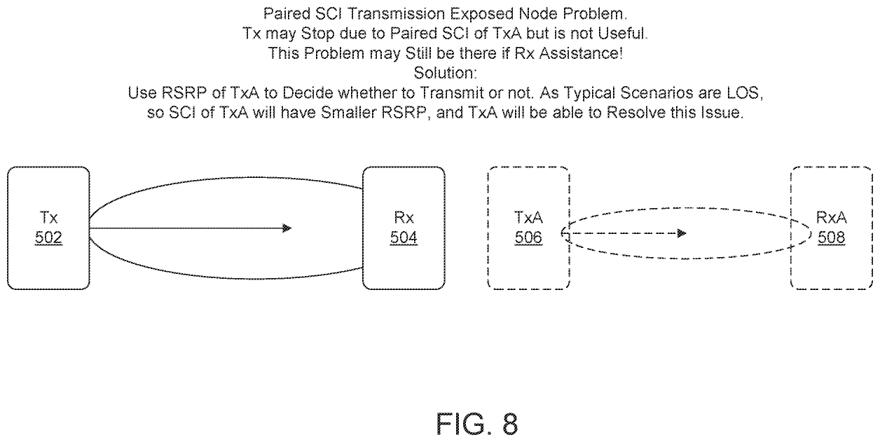

FIG. 8 is a diagram illustrating another example of a paired transmitter and receiver arrangement where paired SCI transmission may lead to an exposed node situation. In FIG. 8, the TxA 506 is transmitting to its intended receiver RxA 508. In certain representative embodiments, the TxA 506 will transmit SCI (e.g., carrying a reservation of future time frequency resources) in the paired direction in addition to transmitting SCI in the intended direction of transmission toward RxA 508. The paired SCI is directed toward the other transmitter Tx which may be performing sensing (e.g., for resource allocation) in order to transmit to its intended receiver Rx 504. Due to relative locations and channel realization, the paired SCI from TxA 506 may be successfully decoded at Tx 502. In this situation, it's the exposed node issue that Tx 502 will detect. For example, the Tx 502 may apply (e.g., determine) information about the location of its intended receiver Rx 504 and/or the location of TxA 506 to estimate whether TxA 506 is located before (e.g., closer to) or after (e.g., further from) its intended receiver Rx 504. If the TxA 506 is located between the Tx 502 and the Rx 504, the Rx 504 may be impacted by interference from TxA 506. If TxA 506 is located after the Rx 504 and transmitting in the opposite direction, the Rx 504 may be receiving no or minimal interference from TxA 506. For example, the Tx 502 may determine and/or receive information associated with the Rx's location, such as information used as part of open loop power control and/or through processing signals received from the Rx 504. For example, the Tx 502 may determine and/or receive information which is an estimate of the location of the TxA 506, such as through the measurements made on the paired SCI which indicates a future reservation. The Tx 502 may use such information to determine the location of the TxA 506. For example, the Tx 502 may ignore the resource reservation indication (e.g., SCI) from the TxA 506 if it estimates that the TxA 506 is located farther away from Rx and/or may use the resources associated with the resource reservation indication (e.g., SCI) from the TxA.

### Multiplexing of SL Control and Data for TDM Transmission of SCIs in Primary and Paired Directions

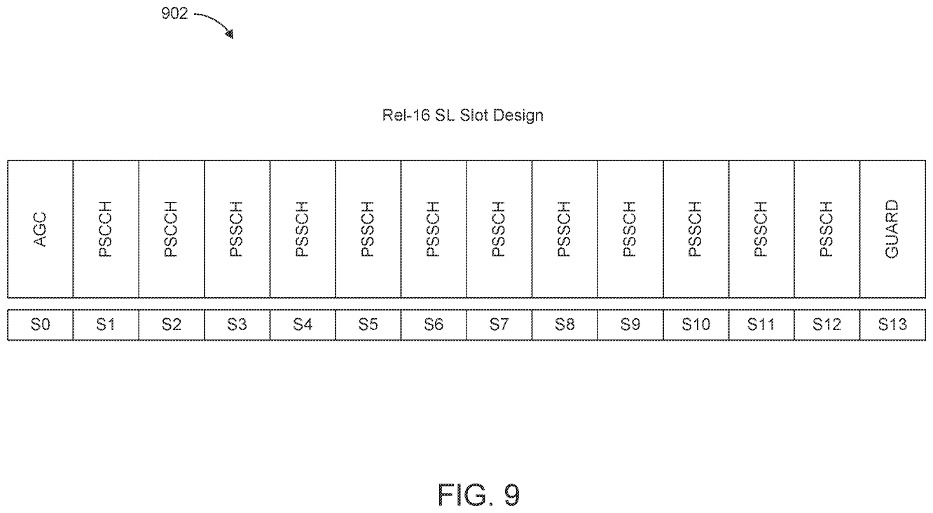

FIG. 9 is a diagram illustrating a structure of a SL slot 902 (e.g., a legacy slot) as in 3GPP Rel-16. As shown in FIG. 9, the SL slot 902 may comprise 14 symbols (e.g., S0, S1, S2, S3, S4, S5, S6, S7, S8, S9, S10, S11, S12 and S13). A first symbol of the SL slot 901 may be reserved for automatic gain control (AGC). The next 2 or 3 (e.g., 2^{nd}, 3^{rd} and/or 4^{th}) symbols may be used for PSCCH transmissions of SCI as per the SL configuration. In FIG. 9, two symbols are associated with PSCCH transmissions. For a SL slot 902 not carrying HARQ feedback (e.g., by PSFCH transmission), except for the last guard symbol (e.g., S13), the remaining symbols may carry SL data via PSSCH transmissions.

In certain representative embodiments, the primary and paired transmissions may be performed sequentially. For example, SL control transmissions and SL data transmissions may be multiplexed where the SL control transmission may comprise SCI transmission in primary and paired directions.

### Primary SCI—Paired SCI—Data

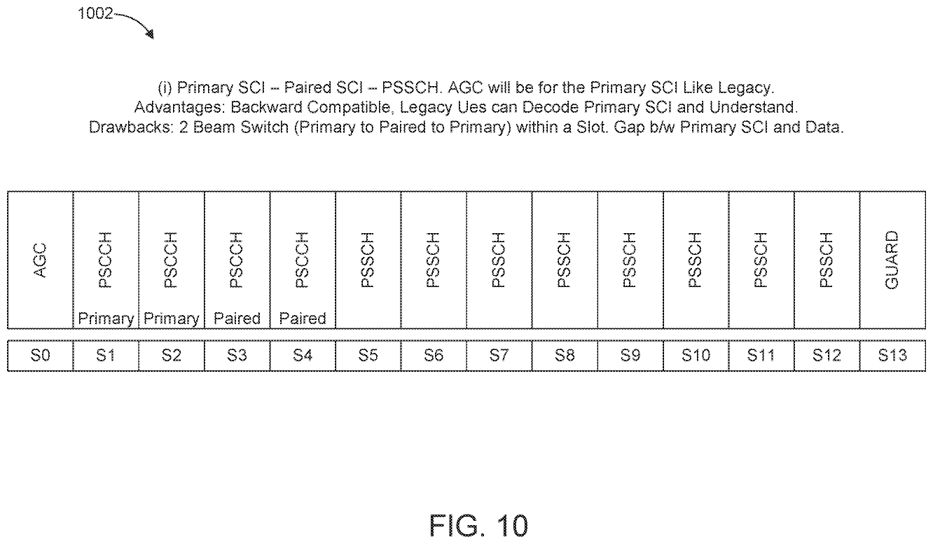

FIG. 10 is a diagram illustrating a representative structure of a SL slot 1002 for paired SCI. As shown in FIG. 10, the SL slot 1002 may comprise multiple symbols, such as 14 symbols. Following the first symbol, which may be reserved for AGC, one or more symbols (e.g., second and third symbols) may be used for PSSCH transmission of primary SCI (e.g., in the intended direction). Following the primary SCI, one or more symbols (e.g., fourth and fifth symbols) may be used for PSSCH transmission of paired SCI (e.g., in the paired direction). For example, a same number of symbols may be used for paired SCI transmission as used for primary SCI transmission. In other examples, a smaller number of symbols may be allocated for paired SCI transmission, such as to reduce overhead. A guard period may be included in the SL slot 1002 (e.g., in a last symbol of the SL slot)

One advantage of the SL slot structure in FIG. 10 is its backward compatibility from a sensing perspective. Any legacy WTRUs 102 which performs sensing based upon (e.g., only using) the primary SCI transmitted in the beginning of the slot 1002 may keep processing the primary SCI. As should be understood from FIG. 10, two beam switching events happen within the slot 1002, first from primary SCI to paired SCI, and then from paired SCI to primary data. This switching and the gap due to paired SCI transmission may have implications on the channel estimation quality. Further, some limitation may be placed on the multiplexing of data in the primary SCI symbols when the SCI is not configured to use all the resource blocks (e.g., due to inserting additional SCI for transmission in an additional direction).

### Paired SCI—Primary SCI—Data

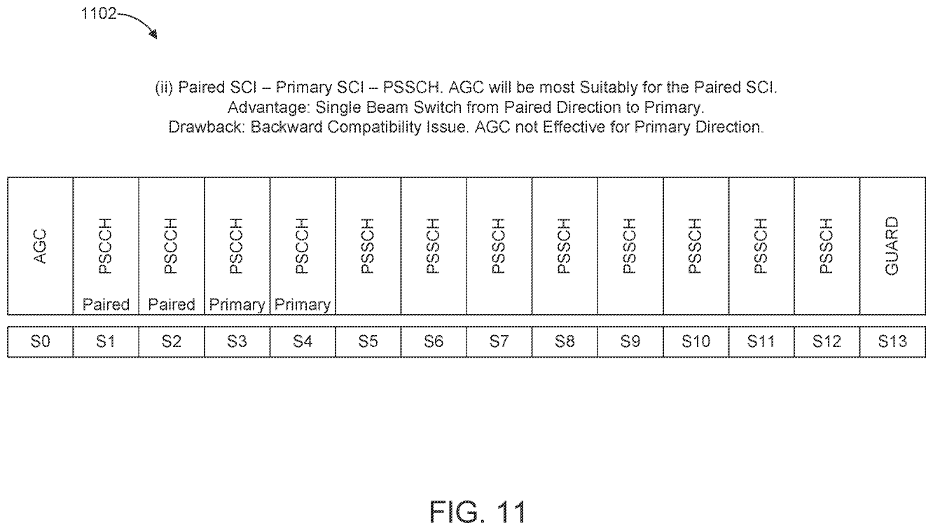

FIG. 11 is a diagram illustrating another representative structure of a SL slot 1102 for paired SCI. As shown in FIG. 11, the SL slot 1102 may comprise multiple symbols, such as 14 symbols. Following the first symbol, which may be reserved for AGC, one or more symbols (e.g., second and third symbols) may be used for PSSCH transmission of paired SCI (e.g., in the paired direction). Following the paired SCI, one or more symbols (e.g., fourth and fifth symbols) may be used for PSSCH transmission of primary SCI (e.g., in the primary direction). For example, a same number of symbols may be used for paired SCI transmission as used for primary SCI transmission. In other examples, a smaller number of symbols may be allocated for paired SCI transmission, such as to reduce overhead. A guard period may be included in the SL slot 1102 (e.g., in a last symbol of the SL slot).

One advantage of the SL slot structure in FIG. 11 is that the primary control and primary data may be transmitted without a gap and there is one beam switch event from paired SCI to primary SCI (e.g., assuming that the AGC symbol is transmitted in the paired direction). As should be understood in FIG. 11, no AGC symbol may be available for the primary direction in the case of one beam switching event. If the AGC symbol is transmitted in the primary direction, then two beam switching events happen within the slot. Further, as shown in FIG. 11, the primary SCI and data may be transmitted in consecutive symbols (e.g., without a gap).

It may appear that there is an issue of backward compatibility as legacy WTRUs 102 may only decode the paired SCI. The primary SCI received through the primary direction may be ignored (e.g., by a legacy WTRU 102) for sensing purposes. A legacy WTRU 102 may receive the paired SCI in their primary direction and may be used to avoid interference scenarios.

### Primary SCI—Data—Paired SCI

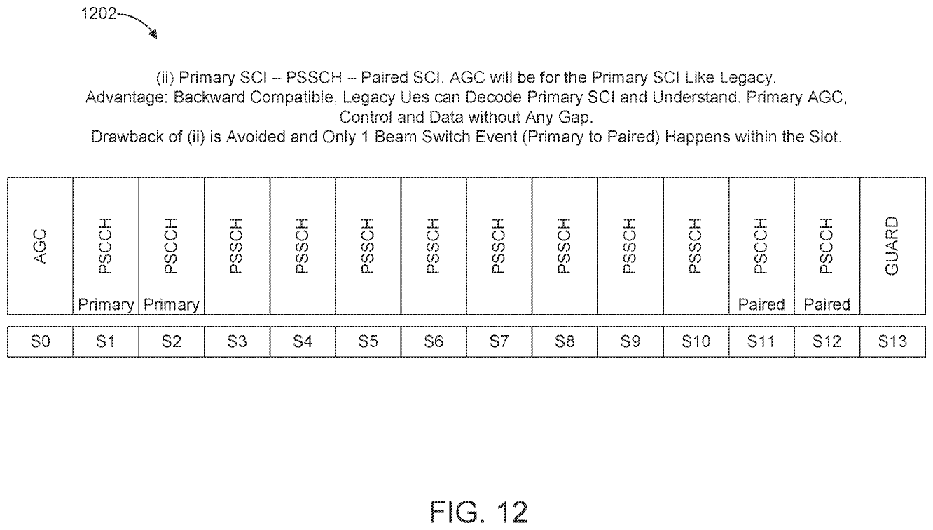

FIG. 12 is a diagram illustrating yet another representative structure of a SL slot 1202 for paired SCI. As shown in FIG. 12, the SL slot 1202 may comprise multiple symbols, such as 14 symbols. Following the first symbol, which may be reserved for AGC, one or more symbols (e.g., second and third symbols) may be used for PSSCH transmission of primary SCI (e.g., in the primary direction). Following the primary SCI, one or more symbols may be used for PSSCH transmission of data (e.g., in the primary direction). Following the data, one or more symbols (e.g., a 12^{th} and 13^{th} symbol) may be used for PSSCH transmission of paired SCI (e.g., in the paired direction) prior to a guard period (e.g., a guard symbol). For example, a same number of symbols may be used for paired SCI transmission as used for primary SCI transmission. In other examples, a smaller number of symbols may be allocated for paired SCI transmission, such as to reduce overhead. A guard period may be included in the SL slot 1202 (e.g., in a last symbol of the SL slot).

The slot structure in FIG. 12 may be similar to the legacy SL slot of FIG. 9 with respect to the arrangement of the AGC symbol, the PSCCH symbols and the PSSCH symbols. One advantage to the SL slot structure of FIG. 12 is that a legacy WTRU 102 may be able to decode second stage SCI which is carried by the PSSCH transmission in the PSCCH symbols. In FIGS. 10 and 11, legacy WTRUs 102 may be unable to decode second stage SCI due to the difference in slot structures shown in FIGS. 10 and 11 as compared to the legacy SL slot 902 of FIG. 9. In FIG. 12, if a DM-RS for PSSCH is understandable by a legacy WTRU 102, the legacy WTRU 102 may be able to estimate the channel using the DM-RS, and decode the 2^{nd} stage SCI carried by the PSSCH transmission. In addition, the AGC, primary SCI and data may have no gap in FIG. 12 (e.g., similar to FIG. 10) and may result in better detection quality, such as compared to FIGS. 10 and 11.

Although not shown in FIGS. 10 to 12, the SL slot may be modified to include PSFCH symbols. The symbols associated with paired SCI may follow the data symbols transmitted in the primary direction and may precede the PSFCH symbols. By incorporating PSFCH symbols, legacy WTRUs 102 may be able to receive HARQ feedback.

For example, a same number of symbols may be used for paired SCI transmission as used for primary SCI transmission. In other examples, a smaller number of symbols may be allocated for paired SCI transmission, such as to reduce overhead.

Extending the Sensing in Additional Paired Directions Based Upon Scenario, Terrain, Geographic Information, Lanes, Traffic Patterns and/or Camera Imaging

In certain representative embodiments, a WTRU 102 may (e.g., be configured to) (i) transmit SCI in a primary direction of interest toward an intended Rx and, (ii) transmit SCI in a paired direction which may be a direction other than the primary direction (e.g., opposite to the primary direction). The paired SCI transmission may be useful for resolving the hidden and exposed node issues, such as in combination with paired sensing for resource allocation which may also be performed by a WTRU 102 in the primary and paired directions.

For example, the paired direction may be a direction other than an opposite direction which is (e.g., substantially) different than 180° opposite to an intended direction in which primary SCI is transmitted. In many real-life scenarios due to road bends, road curves, and/or the general nature of the surrounding terrain, transmitting paired SCI in the 180° direction may not be meaningful and/or most desirable beam direction for performing the paired transmission and/or paired sensing. In the case of a vehicle travelling on a road and at a road bend, the vehicle may be attempting and/or performing SL communication with another vehicle, the primary direction may be in front of the vehicle, but the 180° direction may not be a desirable paired direction. For example, according to the angular bend of the vehicle's path, the paired direction may be selected with respect to paired sensing which are traveling from behind the vehicle. An SL device may have such information from different sources, such as GPS, camera outputs, maps in different formats, etc. An SL Tx may select a paired direction which is different from the 180° direction and which suits the environment based upon the available information from different sensors.

In certain embodiments, a WTRU 102 may be capable of SL transmissions with varying beam widths, and the WTRU 102 may need to perform sensing or transmit (e.g., paired) SCI in a slightly wider beam in the paired direction as compared to the intended direction of primary SCI transmission. A WTRU 102 may be configured to transmit in two or more beams to achieve effective wide-angle coverage in a given direction. For example, a WTRU 102 may transmit two additional beams (e.g., of paired SCI) on each side of its intended direction.

In certain embodiments, a vehicle may be moving in a rightmost (or leftmost) lane, and may determine that there is no lane (e.g., no vehicles) further to the right (or left), and may not perform paired SCI transmission using an additional beam or beamwidth in such directions.

In certain embodiments, if a vehicle is turning, the WTRU 102 of the vehicle may determine to align a primary and/or paired beams for SL sensing and/or SL transmission along the turn.

In certain embodiments, if some vehicles are stranded or in a collision area (e.g., by camera imaging), the sensing and/or transmission directions may be aligned to that direction for information gathering and/or avoidance purposes.

In certain embodiments, there may be one or more paired directions. The additional paired direction(s) may be derived based upon the information gathered through different sensors. In certain embodiments, the additional paired direction(s) may be added after receiving feedback from the intended receiver. For example, where the Rx is receiving strong interference from a given angle, and the Rx may indicate the angle to the Tx. The Tx may then add this location and/or angle to determine an additional paired direction and perform paired SL sending and/or SL transmission in this direction.

For example, where there is only one paired direction, which may be different from the 180° direction, the multiplexing of control and data in the SL slot structures described herein may be utilized to transmit paired SCI simultaneously using two antennas or antenna-panels. If there are multiple paired directions, the SL slot structures described herein may be if the SL device can transmit and/or receive from multiple directions simultaneously.

### Sensing Guidelines and Thresholds

In certain representative embodiments, the primary and paired SCI transmissions may occur in a TDMA manner. The multiplexing may be dictated according to a chosen design. Although many SL devices may be equipped with multiple antennas or antenna-panels, the devices may not all have the required hardware (e.g., digital/analog/RF capabilities), software and/or power components to transmit simultaneously. For example, multiple SL devices may be able to receive and process signals in two directions. Thus, a receiving SL device may perform sensing in the primary and paired directions. Due to TDMA transmission design, an SL device will know that the received SCI was transmitted by a transmitting device in a primary or paired direction. Below we provide some guidelines on how a SL UE performing sensing for resource allocation can treat and process SCIs detected in its primary direction (intended direction of transmission) and paired direction (additional direction(s) where sensing is performed as per the proposal in the embodiment).

A SL WTRU 102 may perform sensing (e.g., for resource allocation) and process SCIs detected in its primary direction (e.g., intended direction of transmission) and paired direction (e.g., additional direction(s) where sensing may be performed. As follows, when a SL device detects an SCI in its primary and paired directions, transmitted by another device in the primary (e.g., primary SCI) and paired (e.g., paired SCI) directions of the transmitting device, the estimated RSRPs for these SCIs at the receiving device may be denoted as:
RSRP_{prTx=>prRx}: RSRP for primary SCI received in primary direction;
RSRP_{prTx=>paRx}: RSRP for primary SCI received in paired direction;
RSRP_{paTx=>prRx}: RSRP for paired SCI received in primary direction; and
RSRP_{paTx=>paRx}: RSRP for paired SCI received in paired direction.

### Primary SCI Received in Primary Direction

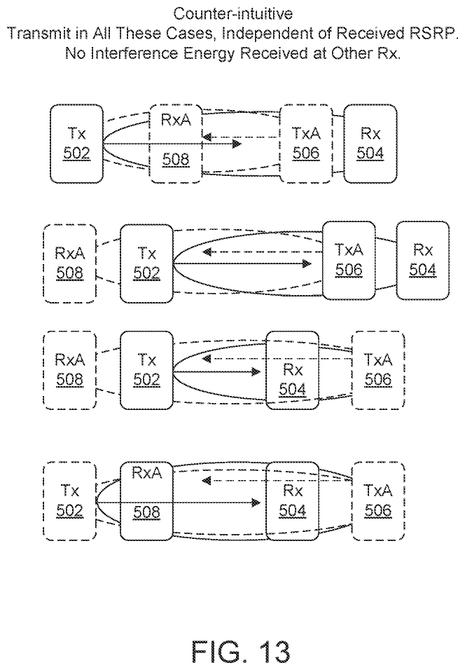

FIG. 13 is a diagram illustrating representative examples of paired transmitter and receiver arrangements. In FIG. 13, two pairs of devices are shown in each example where the TxA 506 is transmitting and sends a reservation to its intended receiver RxA 508. The reservation may be for a given future resource which is in the selection window for another SL device Tx 502 which is performing sensing for resource allocation to transmit to its intended receiver Rx 504. The potential transmitter Tx 502 (e.g., the SCI-sensing WTRU 102) may receive the reservation indication for the future resource from the TxA 506 in its primary direction, and determine that the detected SCI is for the primary direction of the TxA 506.

For example, when the potential transmitter Tx 502 detects in its primary direction an SCI, transmitted in the primary direction from the TxA which is reserving a resource, the two directional transmissions may not result in any interference at their respective receivers. This will happen as both receivers will try to align and receive from their primary directions and will not receive (e.g., minimally receive) any energy from the other transmissions.

In certain representative embodiments, when a first transmitting WTRU 102 performs sensing (e.g., for resource allocation) and detects an SCI which indicates a reservation for a future resource in its intended primary direction, where the SCI was transmitted from a second transmitting WTRU 102 in the primary direction of the second transmitting device, the first transmitting WTRU 102 may ignore the indicated resource reservation. For example, the first transmitting WTRU 102 may proceed to perform SL communication (e.g., in the intended direction) using the same SL resource.

### Primary SCI Received in Paired Direction

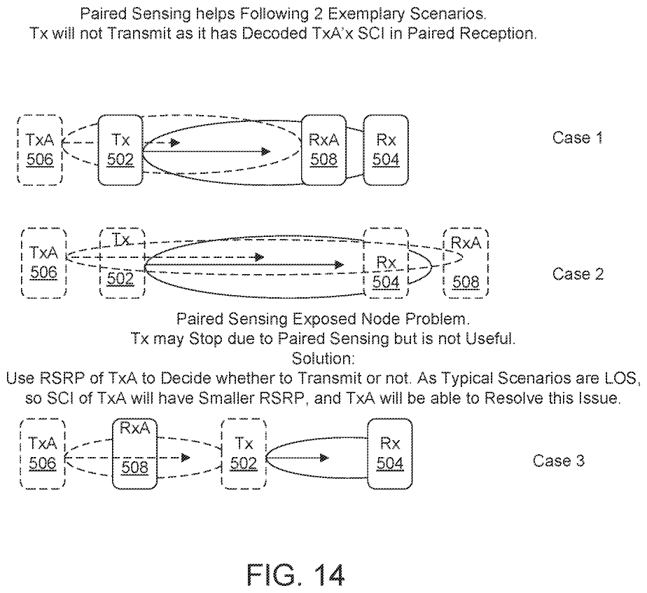

FIG. 14 is a diagram illustrating representative examples of paired transmitter and receiver arrangements for primary SCI received in a paired direction. FIG. 14 shows two pairs of devices where the TxA 506 is transmitting and sends a reservation to its intended receiver RxA 508. The reservation may be for a given future resource which is in the selection window for another SL device Tx 502 which is performing sensing for resource allocation to transmit to its intended receiver Rx 504. The potential transmitter Tx 502 (e.g., the SCI-sensing WTRU 102) may receive the reservation indication for the future resource from the TxA 506 in its paired direction, and determine that the detected SCI is for the primary direction of the TxA 506. In legacy directional schemes, the potential transmitter Tx 502 will not receive the reservation which may lead to hidden node failures.

In certain representative embodiments, the potential transmitter Tx 502 may determine the estimated RSRP is larger than a (e.g., configured) threshold, such as RSRP_{prTx=>paRx}>RSRP_{pr=>pa_TH}. The potential transmitter Tx 502 may remove the indicated resources from its resource selection window (e.g., due to sensing the reservation). For example, the threshold (e.g., RSRP_{pr=>pa_TH}) may be pre-configured. The threshold may be communicated to the SL device by a base station (e.g., gNB 180), such as via system information, layer 1 control signaling (e.g., part of downlink control information), or higher layer signaling (e.g., RRC). To achieve balance between hidden node and exposed node situations, the potential transmitter performing sensing may adapt (e.g., modify) the threshold based upon location of and/or distance to the intended receiver. The values of offsets or weighting factors, which may be used to adapt the threshold may be communicated to the SL device by a base station (e.g., gNB 180), such as via system information, layer 1 control signaling (e.g., part of the downlink control information), or higher layer signaling (e.g., RRC).

### Paired SCI Received in Primary Direction

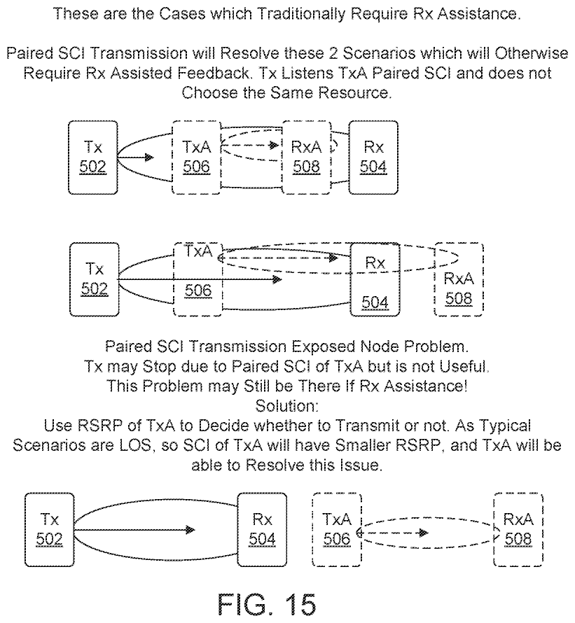

FIG. 15 is a diagram illustrating representative examples of paired transmitter and receiver arrangements for paired SCI received in a primary direction. FIG. 15 shows two pairs of devices where the TxA 506 is transmitting and sends a reservation to its intended receiver RxA 508. The reservation may be for a given future resource which is in the selection window for another SL device Tx 502 which is performing sensing for resource allocation to transmit to its intended receiver Rx. The potential transmitter Tx 502 (e.g., SCI-sensing WTRU 102) may receive the reservation indication for the future resource from the TxA 506 in its primary direction, and determine that the detected SCI is for the paired direction of the TxA 506. In legacy directional schemes, the potential transmitter Tx 502 will not receive the reservation which may lead to hidden node failures.

In certain representative embodiments, the potential transmitter Tx may determine the estimated RSRP is larger than a (e.g., configured) threshold, such as RSRP_{paTx=>prRx}>RSRP_{pa=>pr_TH}. The potential transmitter Tx 502 may remove the indicated resources from its resource selection window (e.g., due to sensing the reservation). For example, the threshold (e.g., RSRP_{pr=>pa_TH}) may be pre-configured. The threshold may be communicated to the SL device by a base station (e.g., gNB 180), such as via system information, layer 1 control signaling (e.g., part of downlink control information), or higher layer signaling (e.g., RRC). To achieve balance between hidden node and exposed node situations, the potential transmitter performing sensing may adapt (e.g., modify) the threshold based upon location of and/or distance to the intended receiver. The values of offsets or weighting factors, which may be used to adapt the threshold may be communicated to the SL device by a base station (e.g., gNB 180), such as via system information, layer 1 control signaling (e.g., part of the downlink control information), or higher layer signaling (e.g., RRC).

### Paired SCI Received in Paired Direction

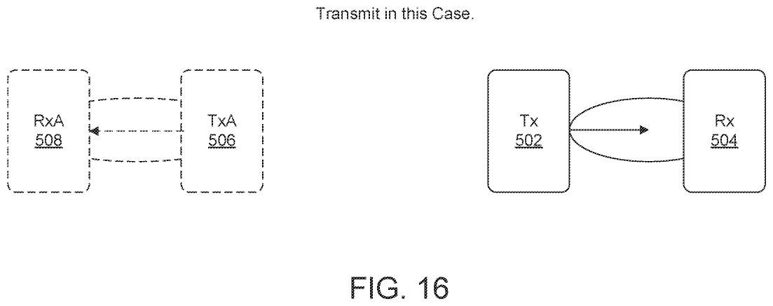

FIG. 16 is a diagram illustrating representative examples of paired transmitter and receiver arrangements for paired SCI received in a paired direction. FIG. 16 shows two pairs of devices where the TxA 506 is transmitting and sends a reservation to its intended receiver RxA 508. The reservation may be for a given future resource which is in the selection window for another SL device Tx 502 which is performing sensing for resource allocation to transmit to its intended receiver Rx 504. The potential transmitter Tx 502 (e.g., SCI-sensing WTRU 102) may receive the reservation indication for the future resource from the TxA 506 in its paired direction, and determine that the detected SCI is for the paired direction of the TxA 506.

Due to SCI transmission in the paired direction and the sensing in the paired direction, the sensing device may detect a very strong SCI indicating a future reservation, but those skilled in the art should appreciate that if the two pairs in this situation use a same time frequency resource simultaneously, the resulting directional receptions may be (e.g., completely) interference free at their respective receiving devices.

In certain representative embodiments, when a first transmitting WTRU 102 performing sensing for resource allocation detects an SCI indicating a reservation for a future resource in its paired direction and where the SCI was transmitted from a second transmitting WTRU 102 in the paired direction of the second transmitting WTRU 102, the first transmitting WTRU 102 may ignore the indicated resource reservation. For example, the first transmitting WTRU 102 may proceed to perform SL communication (e.g., in the intended direction) using the same SL resource.

### Primary and Paired SCI Thresholds

As described herein, a SL device which is performing SL sensing (e.g., for autonomous resource allocation) may ignore received reservations for future resources in cases where interfering transmissions are not expected at the respective receivers, such as where primary SCI is received in the primary direction and/or where paired SCI is received in the paired direction. In cases where, where primary SCI is received in the paired direction and/or where paired SCI is received in the primary direction, a SL device may compare the RSRP of the detected SCI against a threshold. The use of the threshold may strike a balance in terms of suppressing hidden node scenarios and/or exposed node situations.

In certain representative embodiments, resource allocation thresholds (e.g., legacy thresholds) which are configured as part of the configuration for the resource allocation procedure may be applied without modification. In legacy systems, the resource allocation thresholds may be configured per pair of priorities, where one priority is for the detected transmission and the other priority is the own transmission for which resource selection is being performed. Such thresholds may then be increased in an iterative manner if enough resources are not available in the resource selection window.

In certain other representative embodiments, the resource allocation thresholds configured for the resource selection procedure may be modified using the distance and/or location information (e.g., of the reserving Tx and/or intended Rx) available at the SL device which is performing SL sensing. For example, offsets applied to the configured pairs can be part of the configuration. The network may configure different offsets, such as one offset for primary SCI received in the paired direction, and a different offset for the paired SCI received in the primary direction.

### Performance Results

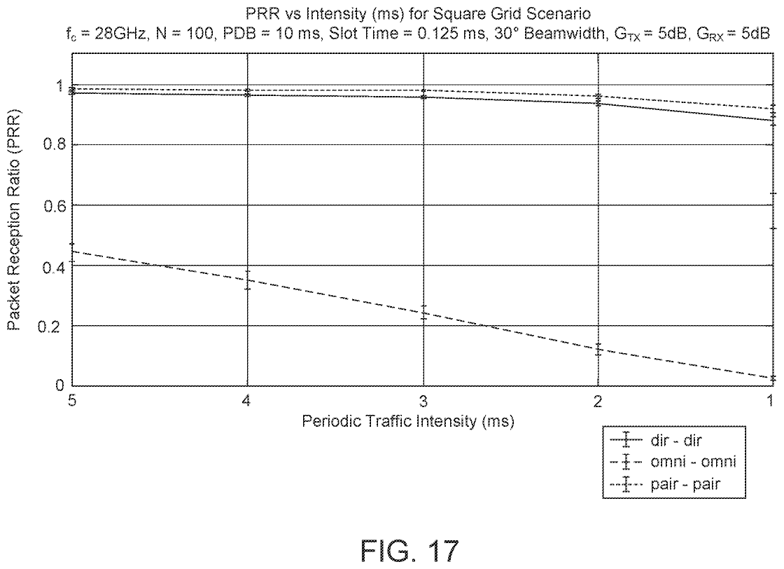

FIG. 17 is a diagram illustrating another example relationship between packet reception ratio (PRR) and periodic traffic intensity for square grid scenarios. In FIG. 17, paired sensing and paired SCI (e.g., 1^{st} stage SCI) transmission (represented as pair-pair in FIG. 17) performance is shown in comparison to sensing and SCI transmission in omnidirectional fashion and in directional fashion (e.g., a directional-to-directional system) with increasing traffic intensity. The performance of paired sensing and paired SCI transmission exceeds that of omnidirectional and directional systems for square grid scenarios.

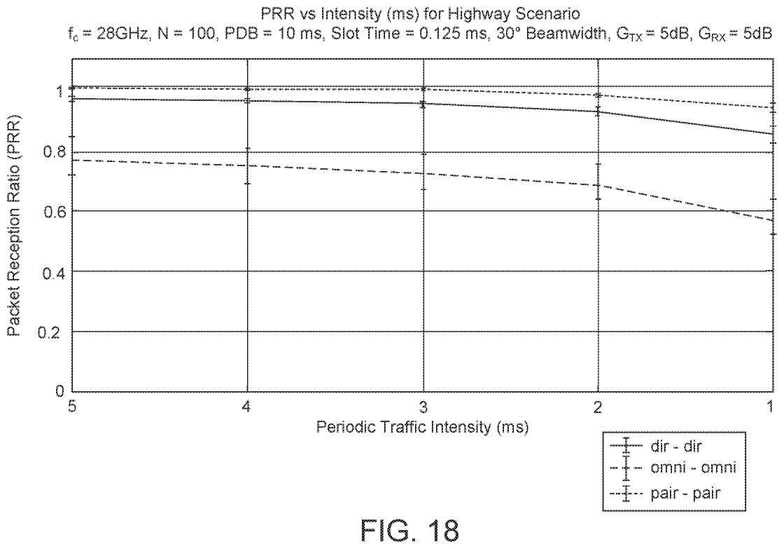

FIG. 18 is a diagram illustrating another example relationship between packet reception ratio (PRR) and periodic traffic intensity for highway scenarios (e.g., collinear scenarios). In FIG. 18, paired sensing and paired SCI (e.g., 1^{st} stage SCI) transmission (represented as pair-pair in FIG. 18) performance is shown in comparison to sensing and SCI transmission in omnidirectional fashion and in directional fashion (e.g., a directional-to-directional system) with increasing traffic intensity. The performance of paired sensing and paired SCI transmission exceeds that of omnidirectional and directional systems for highway scenarios.

The antenna gain and beamwidth of the paired beam is 5 dB for each transmission and reception and 30°, respectively. As can be seen in FIGS. 17 and 18, PRR improvement over both omnidirectional and directional systems is achieved by using paired sensing and paired SCI transmission as described herein. In the square grid scenario, at a traffic intensity of 1 msec, an improvement from 87.8% PRR for directional system to 92% for the paired system is realized. For the collinear highway scenario, the average PRR improves from 85.3% for the directional system to 94.5% for the paired system.

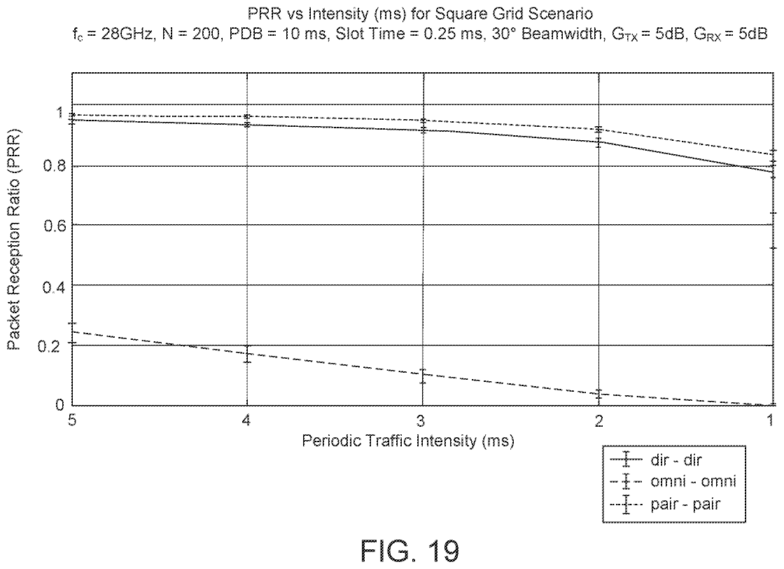

FIG. 19 is a diagram illustrating another example relationship between packet reception ratio (PRR) and periodic traffic intensity for square grid scenarios. In FIG. 19, the slot duration has been increased to 0.25 ms as compared to 0.125 ms in FIG. 17.

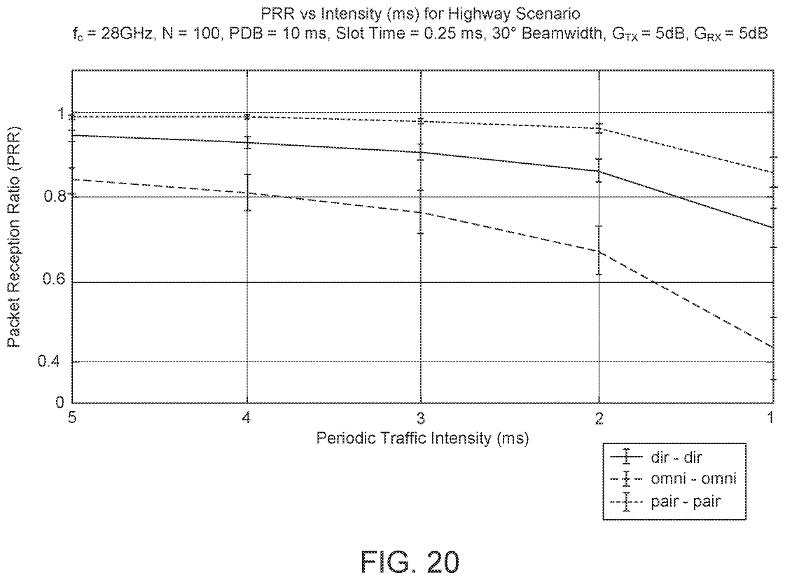

FIG. 20 is a diagram illustrating another example relationship between packet reception ratio (PRR) and periodic traffic intensity for highway scenarios. In FIG. 20, the slot duration has been increased to 0.25 ms as compared to 0.125 ms in FIG. 18.

As can be seen in FIGS. 19 and 20, a longer slot duration leads to a reduction in the available transmission opportunities, and it may be easily observed that the performance gap widens further between the paired and directional systems. For the highway scenario at a traffic intensity of 1 ms, the paired system achieves a PRR of 85.6% compared to the directional system with a PRR of 72.3%, resulting in a performance advantage of 13.3% in favor of the paired system.

As can be seen from FIGS. 17 to 20, the performance gains which may be realized by the paired sensing and paired SCI transmission procedures described herein may be considerable as compared to legacy techniques.

### Example Methods

As an example, a representative method which may be performed by a first WTRU 102 (e.g., a WTRU 102 configured for SL transmission) to allocate resources for use by the first WTRU 102 for a SL transmission to a second WTRU 102 (e.g., a WTRU 102 configured for SL reception) may include the first WTRU 102 determining an estimate for a primary direction of transmission. The first WTRU 102 may derive at least one paired direction which is associated with the primary direction of transmission. After, the first WTRU 102 may perform SCI sensing in the primary and paired directions to detect ongoing SL transmissions and/or reservations (e.g., for a current or upcoming TTI, such as a slot). The first WTRU 102 may then select a SL resource for its transmission to the second WTRU 102 using any sensed SCI in the primary and paired directions. After, the first WTRU may proceed to transmit SL control and data over the selected SL resource. For example, the transmission of SL control information may include SCI transmission in the primary and paired directions (e.g., using TDMA).

In certain representative embodiments, the multiplexing pattern of the SL transmission for the SL slot may be primary SCI, paired SCI, and SL data. In certain representative embodiments, the multiplexing pattern of the SL transmission for the SL slot may be paired SCI, primary SCI, and SL data. In certain representative embodiments, the multiplexing pattern of the SL transmission for the SL slot may be primary SCI, SL data, and paired SCI.

In certain representative embodiments, the first symbol in the SL slot may be an AGC symbol that includes signals present in a subsequent symbol. The transmission of the AGC symbol may be aligned in a same transmission direction (e.g., primary or paired) as the subsequent symbol.

In certain representative embodiments, the paired direction may be 180° opposed to the primary direction.

In certain representative embodiments, the paired direction may include one or more paired directions. For example, the paired directions may be determined by the first WTRU 102 based on feedback information received from the second WTRU 102.

In certain representative embodiments, the first WTRU 102 may select the paired direction using geographic information, terrain information, road information, and/or camera information.

In certain representative embodiments, the first WTRU 102 may ignore the presence of any primary SCIs received in the primary direction of transmission of the first WTRU 102 when selecting the SL resource.

In certain representative embodiments, the first WTRU 102 may ignore the presence of any paired SCIs received in the paired direction of transmission of the first WTRU 102 when selecting the SL resource.

In certain representative embodiments, the first WTRU 102 may apply a first threshold to determine whether to ignore primary SCIs received in the paired direction. In certain representative embodiments, the first WTRU 102 may apply a second threshold to determine whether to ignore paired SCIs received in the primary direction. In certain representative embodiments, the first WTRU 102 may apply a same threshold to determine whether to ignore primary SCIs received in the paired direction and paired SCIs received in the primary direction.

In certain representative embodiments, the first WTRU 102 may receive information indicating any of the thresholds as part of a resource allocation configuration. For example, the resource allocation configuration may include information indicating threshold information for each priority pair between the first WTRU's own transmission priority and the priority of detected transmissions.

In certain representative embodiments, the first WTRU 102 may modify any of the thresholds based on the location of a third WTRU 102 associated with sensed SCI and/or the location of the second WTRU 102.

SCI Transmission in Primary and Paired Directions with Parallel Transmission

In highly directional systems operating at very high carrier frequencies (e.g., 6 GHZ and above), collinear transmissions may be detrimental from a collision perspective and may need to be considered while performing SL sensing (e.g., for SL autonomous resource allocation).

In certain representative embodiments, a SL Tx may perform a SL transmission, and SCI may be transmitted in the primary direction and in the paired direction. The SCI may be transmitted at a same time (e.g., simultaneously) in the primary and the paired directions in such cases where such transmission capabilities are present. For example, a SL device may be capable of simultaneous transmission when equipped with more than one antenna panel.

### SCI Sensing for Autonomous Resource Allocation

In certain representative embodiments, a potential SL transmitter (e.g., WTRU 102) may perform an autonomous resource allocation procedure which may include SCI sensing in (i) an intended direction of transmission, and (ii) at least one direction paired to the intended direction of transmission. For example, the SL transmitter may be capable of transmitting in multiple directions simultaneously, such as when equipped with multiple antenna panels. In the case of vehicles, multiple antenna panels may be mounted on the vehicle which may enable the vehicle (e.g., a WTRU 102 provided on the vehicle) to operate as a SL device which may simultaneously transmit and/or receive signals in multiple directions.

For example, it may be advantageous for the SL device to perform paired sensing for autonomous resource allocation with respect to an upcoming SL transmission in the intended transmission direction and in the paired direction (e.g., simultaneously) in order to receive a majority of transmissions with which its own upcoming transmission may have a collision risk.

As described above, FIG. 9 is a diagram illustrating a structure of a SL slot (e.g., a legacy slot) as in 3GPP Rel-16. In FIG. 9, the SL slot may include, for example, 14 symbols. A first symbol may be used for automatic gain control (AGC), the next 2 or 3 symbols may be used to send SCI via PSCCH transmission as per a SL configuration. In FIG. 9, two symbols are attributed for PSCCH. For the SL slot which does not include HARQ feedback sent via PSFCH transmission the remaining symbols, other than the last guard symbols, may carry SL data carried via PSSCH transmission.

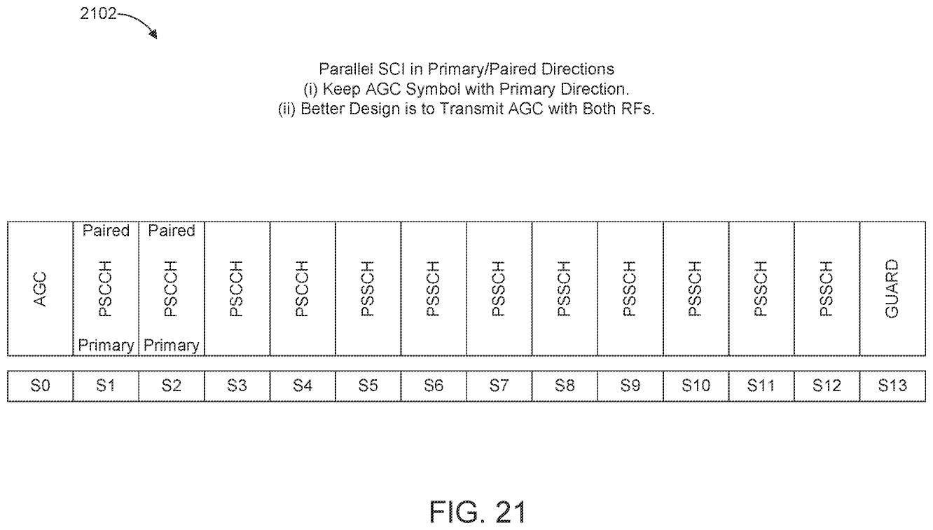

In certain representative embodiments, SCI may be transmitted in the primary and paired directions simultaneously (e.g., over the same symbols of an SL slot). FIG. 21 is a diagram illustrating another representative structure of a SL slot 2102 for paired SCI where the SCI is transmitted in the primary and paired directions at the same time. For example, a SL device may use separate antenna panels and power amplifiers to send the parallel transmissions at the same time. In cases where, SCI transmission in the primary and paired directions may undergo different signal processing, though this may be minimal. In FIG. 21, primary SCI may be transmitted in the primary direction in 2 or 3 symbols following an AGC symbol. Paired SCI may be transmitted in at least one paired direction in the 2 or 3 symbols following the AGC symbol. The primary SCI and paired SCI may be transmitted via PSCCH transmissions. Data may be multiplexed in the SL slot 2102 in PSSCH symbols. The paired transmissions for SL control (e.g., primary and paired SCI) are transmitted over the same set of symbols, such by using multiple antennas and/or antenna-panels. The AGC symbol in the SL slot 2102 may be a copy of the second symbol. For example, the AGC symbol for each of the primary and paired SCIs may be transmitted in their respective directions. As another example, the AGC symbol transmission for the paired direction may be ignored (e.g., omitted). This may reduce the power consumption at the transmitting WTRU 102 but may result in lower detection quality for the paired SCI.

Extending Sensing in Additional Paired Directions Based on Scenario, Terrain, Geographical Information, Lanes, Traffic Pattern, and/or Camera Imaging

In certain representative embodiments, SCI may be transmitted (i) in a primary direction of interest toward an intended Rx 504 and also (ii) in a direction opposite to the primary direction (e.g., a paired direction). This paired SCI transmission becomes very useful against the hidden and exposed node issues in combination with paired sensing for resource allocation, also performed in the primary and paired direction.

In certain representative embodiments, the paired direction may be a direction other than 180° opposite to the primary direction. In many real-life scenarios due to road bends, road curves, and/or the general nature of the surrounding terrain, transmitting paired SCI in the 180° direction may not be meaningful and/or most desirable beam direction for performing the paired transmission and/or paired sensing. In the case of a vehicle travelling on a road and at a road bend, the vehicle may be attempting and/or performing SL communication with another vehicle, the primary direction may be in front of the vehicle, but the 180° direction may not be a desirable paired direction. For example, according to the angular bend of the vehicle's path, the paired direction may be selected with respect to paired sensing which are traveling from behind the vehicle. An SL device may have such information from different sources, such as GPS, camera outputs, maps in different formats, etc. An SL Tx 502 may select a paired direction which is different from the 180° direction and which suits the environment based upon the available information from different sensors.

In certain embodiments, a WTRU 102 may be capable of SL transmissions with varying beam widths, and the WTRU 102 may need to perform sensing or transmit (e.g., paired) SCI in a slightly wider beam in the paired direction as compared to the intended direction of primary SCI transmission. A WTRU 102 may be configured to transmit in two or more beams to achieve effective wide-angle coverage in a given direction. For example, a WTRU 102 may transmit two additional beams (e.g., of paired SCI) on each side of its intended direction.

In certain embodiments, a vehicle may be moving in a rightmost (or leftmost) lane, and may determine that there is no lane (e.g., no vehicles) further to the right (or left), and may not perform paired SCI transmission using an additional beam or beamwidth in such directions.

In certain embodiments, if a vehicle is turning, the WTRU 102 of the vehicle may determine to align a primary and/or paired beams for SL sensing and/or SL transmission along the turn.

In certain embodiments, if some vehicles are stranded or in a collision area (e.g., by camera imaging), the sensing and/or transmission directions may be aligned to that direction for information gathering and/or avoidance purposes.

In certain embodiments, there may be one or more paired directions. The additional paired direction(s) may be derived based upon the information gathered through different sensors. In certain embodiments, the additional paired direction(s) may be added after I feedback from the intended receiver. For example, where the Rx is receiving strong interference from a given angle, and the Rx may indicate the angle to the Tx. The Tx may then add this location and/or angle to determine an additional paired direction and perform paired SL sending and/or SL transmission in this direction.

For example, where there is only one paired direction, which may be different from the 180° direction, the multiplexing of control and data in the SL slot structures described herein may be utilized to transmit paired SCI simultaneously using two antennas or antenna-panels. If there are multiple paired directions, the SL slot structures described herein may be if the SL device can transmit and/or receive from multiple directions simultaneously.

### Primary and Paired SCI Transmissions

In certain representative embodiments, SCI may be transmitted (i) in a primary direction of interest toward an intended Rx and also (ii) in a direction opposite to the primary direction (e.g., a paired direction) in the same symbols of a same SL slot (e.g., simultaneously). For example, upon a WTRU 102 decoding a SCI, the WTRU 102 may not know whether the decoded SCI is from a primary direction of transmission (where a subsequent PSSCH transmission may occur) or from the paired direction (where no PSSCH transmission may occur) for sensing purposes as described herein. In general, this may lead to increased exposed node issues, as additional WTRU 102 become able to decode the SCI transmitted in primary and paired directions but may not actually experience interference or collision on the same time frequency resources. The neighboring WTRUs 102 decoding a given SCI may be better informed for resource allocation purpose if the neighboring WTRUs 102 are able to determine whether the decoded SCI is from a primary or paired direction.

In certain representative embodiments, information (e.g., an indication) may be provided with which a decoding SL device may use to determine whether a given SCI is associated with an intended direction of transmission or for a paired direction of transmission. For example, the information may distinguish a paired SCI transmission from a primary SCI transmission or vice versa.

### Reserved Bits in SCI

In certain representative embodiments, reserved bits may be present in the SCI (e.g., primary and/or paired SCI) for distinguishing the primary SCI from paired SCI. For example, the reserved bits may be used to indicate (e.g., identify) the paired SCI. A paired SCI can have one or more reserved bits set to a given value (e.g., to indicate the SCI was transmitted in the paired direction). A legacy WTRU 102, upon decoding an SCI with such reserved bits may discard the SCI if a different value for the reserved bits is expected. If a legacy WTRU 102 handles a SCI with such reserved bits as a normal SCI, the SCI may not be discarded. A WTRU 102 which is configured to operate according to the paired scheme may expect the signaling in the reserved bits and process the SCI as a paired SCI.

### Re-Farm SCI Bit Fields

In certain representative embodiments, the SCI transmitted in the paired direction may not have associated data (e.g., one or more PSSCH transmissions) in the symbols of the same SL slot in which the SCI is transmitted. For example, one or more bit fields used to indicate some aspects of 2^{nd} stage SCI and/or PSSCH (e.g., PSSCH DM-RS, 2^{nd} stage SCI identification, PSSCH MCS, etc.), may be re-farmed (e.g., reused) to indicate the SCI is transmitted as a paired SCI. For example, a fixed value may be assigned (e.g., used) for one or a combination of bit fields associated with the 2^{nd} stage SCI and/or PSSCH to identify the SCI in the SL slot is a paired SCI. A WTRU 102 upon detecting such fixed values, may determine the decoded SCI was transmitted in the paired direction (e.g., is a paired DCI). A legacy WTRU 102 may discard such SCI when the fixed values of such bit fields are unexpected.

### SCI Scrambling

In certain representative embodiments, the SCI may be scrambled (e.g., an XOR operation) with a (e.g., predetermined or configured) sequence. For example, the sequence may be known to all WTRUs 102 (e.g., performing SL communications). Scrambling with the sequence may be performed at the SL Tx 502 prior to channel coding step when computing the cyclic redundancy check (CRC). A SL Rx 504 will decode the SCI, and will perform CRC check. As an example, the CRC check may be performed once without scrambling and once with the sequence scrambling for indicating paired SCI. On condition that the CRC check passes without the scrambling, the receiving WTRU 102 may determine that the SCI was from the primary direction of transmission. On condition that the CRC check passes with the sequence scrambling, the receiving WTRU 102 may determine the SCI was from the paired direction of transmission. For example, a simple scrambling sequence may be a sequence of all 1's. This would lead to inverting all 1 bits to 0 bits and vice versa. A legacy WTRU 102 may not be able to decode the paired SCI transmitted in this manner as the legacy WTRU 102 may not be provided with or perform decoding with the scrambling sequence.

### SCI Reference Signal

In certain representative embodiments, the SCI may by distinguished as either primary SCI or paired SCI using a reference signal (e.g., SCI DM-RS) as an indication. For example, different DM-RS sequences may be used between the primary and paired SCI transmissions. Scrambling may be performed on the DM-RS sequence with a given sequence known to all WTRUs 102 (e.g., performing SL communications). The receiving WTRU 102 may perform the correlation using two different DM-RS sequences, one with and one without scrambling. From the correlation results, the WTRU 102 may determine whether the received SCI is a primary SCI or a paired SCI, and may prepare channel estimates and perform SCI decoding accordingly. A legacy WTRU 102 may not apply the appropriate DM-RS processing and hence may not be able to decode such a paired SCI.

### Performance Indication

In certain representative embodiments, the paired SCI may be transmitted in a TDMA manner with the primary SCI. In certain representative embodiments, capable SL devices may transmit primary and paired SCIs simultaneously (e.g., in the same symbols of a SL slot). Such capabilities may depend on additional antennas, RF, HW and processing requirements for simultaneous transmission in two or more directions. Apart from performance, simultaneous transmission is also a matter of HW and computational capabilities. Due to simultaneous transmission of primary and paired SCI, interference levels may be higher during the control symbols.

As a matter of performance, the TDMA transmission of primary and paired SCI may lead to a data resource reduction within a slot (e.g., the resource elements available to carry actual data may decrease). For example, smaller data packets may be transmitted in the TDMA manner. In another example, data packet size may not be reduced and puncturing and rate-matching operations may be used to fit a same data packet in a reduced time frequency resource. For the performance of these examples, at a traffic arrival rate of 1 ms and where all packets are assumed to be transmitted over one sub-channel, the throughput of TDMA approach may be approximately 1.92 Mbps and the throughput of the parallel transmission approach may reach approximately 2.4 Mbps. In other words, an improved (e.g., 20% additional) throughput may be achieved using the parallel transmission of SCI (e.g., in the same symbols of a slot). As noted earlier, the throughput may depend on different HW/SW requirements for the SL devices implementing each approach. Both the TDMA approach and the parallel transmission approach achieve performance improvements over the legacy systems and one of these approaches as described herein can be adopted according to device capabilities and/or application requirements.

### Example Methods

As an example, a representative method which may be performed by a first WTRU 102 (e.g., a WTRU 102 configured for SL transmission) to allocate resources for use by the first WTRU 102 for a SL transmission to a second WTRU 102 (e.g., a WTRU 102 configured for SL reception) may include the first WTRU 102 determining an estimate for a primary direction of transmission. The first WTRU 102 may derive at least one paired direction which is associated with the primary direction of transmission. After, the first WTRU 102 may perform SCI sensing in the primary and paired directions to detect ongoing SL transmissions and/or reservations (e.g., for a current or upcoming TTI, such as a slot). The first WTRU 102 may then select a SL resource for its transmission to the second WTRU 102 using any sensed SCI in the primary and paired directions. After, the first WTRU 102 may proceed to simultaneously transmit SL control and data over the selected SL resource. For example, the transmission of SL control information may include SCI transmission in the primary and paired directions in the same symbols of a slot.

In certain representative embodiments, the first symbol in the SL slot may be an AGC symbol that includes signals present in a subsequent symbol. The transmission of the AGC symbol may be aligned in a same transmission direction (e.g., primary or paired) as the subsequent symbol. The transmission of the AGC symbol may be aligned in the same transmission directions as the primary SCI and the paired SCI.

In certain representative embodiments, the paired direction may be 180° opposed to the primary direction.

In certain representative embodiments, the paired direction may include one or more paired directions. For example, the paired directions may be determined by the first WTRU 102 based on feedback information received from the second WTRU 102.

In certain representative embodiments, the first WTRU 102 may select the paired direction using geographic information, terrain information, road information, and/or camera information.

In certain representative embodiments, the first WTRU 102 may ignore the presence of any primary SCIs received in the primary direction of transmission of the first WTRU 102 when selecting the SL resource.

In certain representative embodiments, the first WTRU 102 may ignore the presence of any paired SCIs received in the paired direction of transmission of the first WTRU 102 when selecting the SL resource.

In certain representative embodiments, the first WTRU 102 may apply a first threshold to determine whether to ignore primary SCIs received in the paired direction. In certain representative embodiments, the first WTRU 102 may apply a second threshold to determine whether to ignore paired SCIs received in the primary direction. In certain representative embodiments, the first WTRU 102 may apply a same threshold to determine whether to ignore primary SCIs received in the paired direction and paired SCIs received in the primary direction.

In certain representative embodiments, the first WTRU 102 may receive information indicating any of the thresholds as part of a resource allocation configuration. For example, the resource allocation configuration may include information indicating threshold information for each priority pair between the first WTRU's own transmission priority and the priority of detected transmissions.

In certain representative embodiments, the first WTRU 102 may modify any of the thresholds based on the location of a third WTRU 102 associated with sensed SCI and/or the location of the second WTRU 102.

In certain representative embodiments, the first WTRU 102 may include an indication in the SCI transmitted to distinguish the primary SCI and the paired SCI from each other and/or the transmission direction thereof. For example, the indication may be included in the paired SCI to identify the SCI as being transmitted in a paired direction.

In certain representative embodiments, the first WTRU 102 may set one or more reserved bits in the paired SCI to indicate transmission in the paired direction.

In certain representative embodiments, the first WTRU 102 may set one or more bit fields (e.g., in combination) in the paired SCI to indicate transmission in the paired direction.

In certain representative embodiments, the first WTRU 102 may scramble the SCI with a sequence to indicate the transmission direction. For example, the first WTRU 102 may scramble the paired SCI with a sequence which is configured to indicate transmission was performed in the paired direction.

In certain representative embodiments, the first WTRU 102 the indication of the primary SCI and/or paired SCI transmission direction may be provided by DM-RS. For example, the DM-RS associated with the paired SCI may be arranged to indicate the paired SCI.

### Simulation Parameters

With respect to FIGS. 3-4 and 17-20, square grid and high scenarios were used. For the square grid scenarios, a 100 m×100 m grid was simulated with unicast SL communication in 100 randomly deployed pairs consisting of one SL WTRU 102 acting as a transmitter and another SL WTRU 102 acting as a receiver (e.g., 200 total SL devices deployed in the square grid). A Tx-Rx distance for the pairs was distributed uniformly between 10 and 40 meters. For the highway scenarios, a section of road of length 4 km with 100 vehicle-mounted WTRUs were deployed inside it following the guidelines specified in 3GPP TR 37.885. There were 50 Tx-Rx pairs in the highway scenarios. For a Tx WTRU 102, the corresponding Rx WTRU 102 was chosen randomly from the vehicles located within a distance of 150 m.

A periodic traffic model was used for the simulations where a new packet arrives at each WTRU every X ms. In our simulations, we present results for X={5, 4, 3, 2, 1} ms. The resource reservation interval (RRI) of the Mode 2 resource allocation procedure is kept the same as the traffic intensity. There were 10 subchannels available for SL transmissions and the size of each subchannel was 10 PRBs. Packet size for each Tx WTRU's traffic was uniformly distributed between 1-10 subchannels. In a single run of the simulations, the packet size of the traffic of each Tx WTRU remained the same.

Directional transmission and reception of data (e.g., PSSCH transmissions) is assumed with a directional antenna beamwidth of 30° at both the Tx WTRUs and Rx WTRUs. For directional sensing and directional transmission of SCI (e.g., PSCCH transmissions), the directional antenna beamwidth was also 30°. Directional antenna gain is assumed to be equal to 5 dB for both the Tx WTRUs and the Rx WTRUs. When omnidirectional sensing or omnidirectional SCI transmissions are used (“omni-omni” systems), no additional antenna gain is assumed, and the transmission/reception happens in all directions (e.g., 360°). Further, a slot time of 0.125 ms (e.g., SCS=120 kHz) was used for both the squared grid and the highway single-lane scenarios unless otherwise noted.

HARQ ACK/NACK feedback-based retransmissions were not considered in the simulations. For each packet, three possible outcomes were considered. If a packet was transmitted and received successfully, it is counted as a “success”. If the packet is transmitted after selecting a resource using the Mode 2 procedure, but is received with error (e.g., low signal-to-interference plus noise ratio (SINR)), then it is counted as a collision. If the Mode 2 resource selection procedure cannot find enough available resources (e.g., >20% of candidate resources in the selection window) for the packet, it was discarded and counted as a “failure”.

Packet detection and decoding was based on the received SINR. For the data channel, the SINR threshold for successful reception of data was 10 dB. For the control channel, we considered a 5 dB SINR threshold for decoding the received SCI. The same 5 dB threshold was applied while considering the set of received and decoded SCIs for the Mode 2 resource allocation procedure. The carrier frequency of the system was 28 GHZ. 3GPP line-of-sight (LoS) path loss models for highway V2X scenario and indoor-office scenarios, were used for the highway single-lane and square grid deployments respectively.

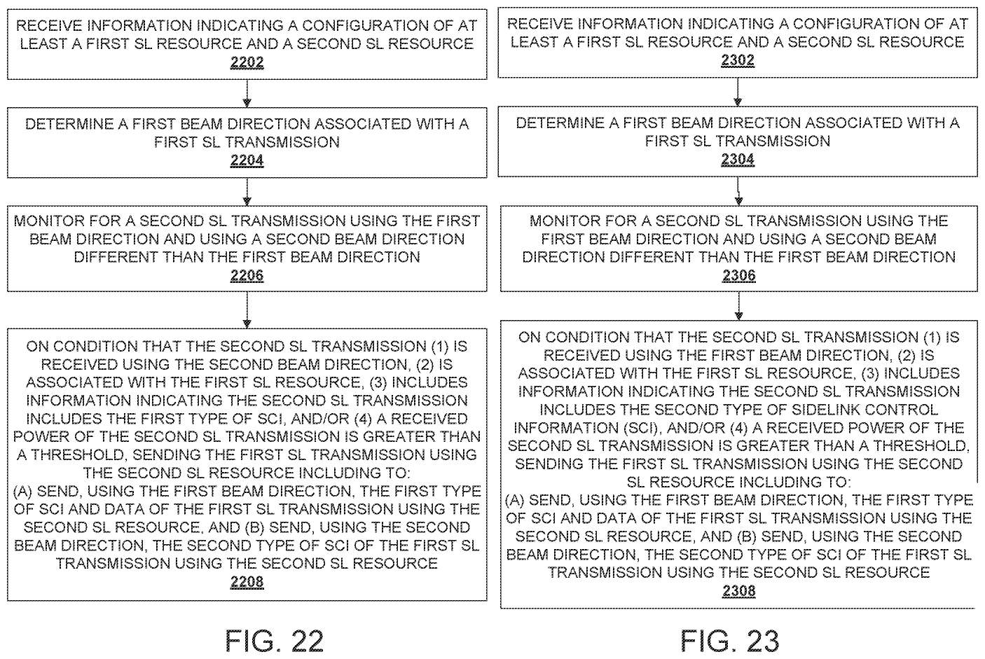

FIG. 22 is a diagram illustrating a representative example of a communication procedure using first and second types of SCI. The procedure of FIG. 22 may be implemented by a WTRU 102 which includes a processor 118 and a transceiver 120. For example, a first type of SCI may be primary SCI and/or a second type of SCI may be paired SCI. At 2202 in FIG. 22, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2204, the WTRU 102 may determine a first beam direction (e.g., antenna panel, first beam, and/or first direction) associated with a first SL transmission. For example, the first beam direction may be associated with a primary direction of the first SL transmission. After 2204, the WTRU 102 may monitor for a second SL transmission using the first beam direction and using a second beam direction which is different than the first beam direction at 2206. For example, the second beam direction may be associated with a paired direction of the first SL transmission. At 2208, on condition of any of the second SL transmission (1) is received using the second beam direction (e.g., from the paired direction), (2) is associated with the first SL resource, (3) includes information indicating the second SL transmission includes the first type of SCI (e.g., is primary SCI from another WTRU 102), and/or (4) a received power of the second SL transmission is greater than a (e.g., first) threshold, the WTRU 102 may send the first SL transmission using the second SL resource as described herein. For example, the sending of the first SL transmission sent at 2208 may include to (A) send, using the first beam direction, the first type of SCI and data of the first SL transmission using the second SL resource, and (B) send, using the second beam direction, the second type of SCI of the first SL transmission using the second SL resource.

FIG. 23 is a diagram illustrating another representative example of a communication procedure using first and second types of SCI. The procedure of FIG. 23 may be implemented by a WTRU 102 which includes a processor 118 and a transceiver 120. For example, a first type of SCI may be primary SCI and/or a second type of SCI may be paired SCI. At 2302 in FIG. 23, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2304, the WTRU 102 may determine a first beam direction (e.g., first antenna panel, first beam, and/or first direction) associated with a first SL transmission. For example, the first beam direction may be associated with a primary direction of the first SL transmission. After 2304, the WTRU 102 may monitor for a second SL transmission using the first beam direction and using a second beam direction which is different than the first beam direction at 2306. For example, the second beam direction may be associated with a paired direction of the first SL transmission. At 2208, on condition of any of the second SL transmission (1) is received using the first beam direction (e.g., from the primary direction), (2) is associated with the first SL resource, (3) includes information indicating the second SL transmission includes the second type of SCI (e.g., is primary SCI from another WTRU 102), and/or (4) a received power of the second SL transmission is greater than a (e.g., second) threshold, the WTRU 102 may send the first SL transmission using the second SL resource as described herein. For example, the sending of the first SL transmission sent at 2308 may include to (A) send, using the first beam direction, the first type of SCI and data of the first SL transmission using the second SL resource, and (B) send, using the second beam direction, the second type of SCI of the first SL transmission using the second SL resource.

For example, in certain representative embodiments, such as in FIGS. 22 and/or 23, the first beam direction may associated with a first antenna panel and/or a first beam, and/or the second beam direction may be associated with a second antenna panel, a second direction (e.g., opposite the first direction) and/or a second beam (e.g., opposite the first beam). As an example, a first antenna panel may be located on a first side of the WTRU 102 and a second antenna panel may be located on a second side of the WTRU 102.

For example, in certain representative embodiments, such as in FIGS. 22 and/or 23, the monitoring for the second SL transmission using the first beam direction and using the second beam direction may include to receive the second SL transmission (e.g., from another WTRU 102) using the first SL resource (e.g., via the first or second antenna panel).

For example, in certain representative embodiments, such as in FIGS. 22 and/or 23, the (e.g., first and/or second type) SCI of the second SL transmission may include information indicating a resource reservation (e.g., of the first or second SL resource). For example, the (e.g., first and/or second type) SCI of the first SL transmission may include information indicating a resource reservation (e.g., of the first or second SL resource).

For example, in certain representative embodiments, such as in FIGS. 22 and/or 23, the sending, using the first beam direction, of the first type of SCI of the first SL transmission using the second SL resource may be during (e.g., occur in) one or more first symbols of a transmission time interval (TTI), such as a subframe. For example, in certain representative embodiments such as in FIGS. 22 and/or 23, the sending, using the second beam direction, of the second type of SCI of the first SL transmission using the second SL resource may be during one or more second symbols, different than the one or more first symbols, of the same TTI, such as the same subframe.

For example, in certain representative embodiments, such as in FIGS. 22 and/or 23, the first type of SCI of the first SL transmission may include one or more bits (e.g., reserved bits and/or a combination of bits) distinguishing the first type of SCI of the first SL transmission from the second type of SCI of the first SL transmission.

For example, in certain representative embodiments, such as in FIGS. 22 and/or 23, the second type of SCI of the first SL transmission may include one or more bits (e.g., reserved bits and/or a combination of bits) distinguishing the second type of SCI of the first SL transmission from the first type of SCI of the first SL transmission.

For example, in certain representative embodiments, such as in FIGS. 22 and/or 23, the sending, using the first beam direction, the first type of SCI and data of the first SL transmission using the second SL resource may include to send, using the first beam direction, a first demodulation reference signal (DM-RS) sequence which is associated with (e.g., identifies) the first type of SCI.

For example, in certain representative embodiments, such as in FIGS. 22 and/or 23, the sending, using the second beam direction, the second type of SCI of the first SL transmission using the second SL resource may include to send, using the second beam direction, a second demodulation reference signal (DM-RS) sequence which is associated with (e.g., identifies) the second type of SCI.

For example, in certain representative embodiments, such as in FIGS. 22 and/or 23, the first type of SCI of the first SL transmission may be scrambled (e.g., prior to being sent) using a first scrambling sequence associated with the first type of SCI and/or the second type of SCI of the first SL transmission may be scrambled (e.g., prior to being sent) using a second scrambling sequence associated with the second type of SCI.

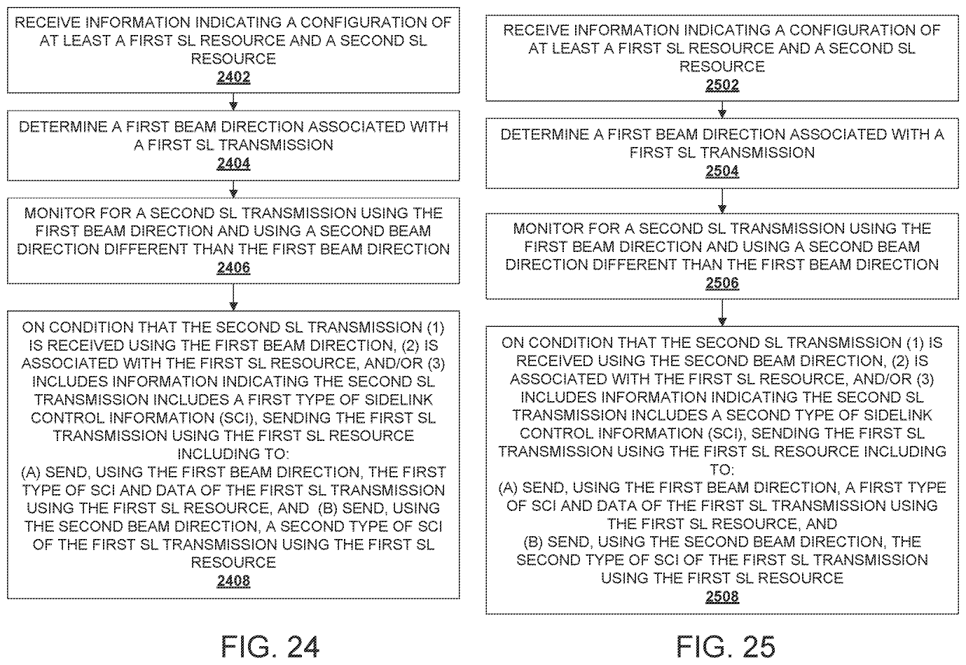

FIG. 24 is a diagram illustrating another representative example of a communication procedure using first and second types of SCI. The procedure of FIG. 24 may be implemented by a WTRU 102 which includes a processor 118 and a transceiver 120. For example, a first type of SCI may be primary SCI and/or a second type of SCI may be paired SCI. At 2402 in FIG. 24, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2404, the WTRU 102 may determine a first beam direction (e.g., first antenna panel, first beam, and/or first direction) associated with a first SL transmission. For example, the first beam direction may be associated with a primary direction of the first SL transmission. After 2404, the WTRU 102 may monitor for a second SL transmission using the first beam direction and using a second beam direction which is different than the first beam direction at 2406. For example, the second beam direction may be associated with a paired direction of the first SL transmission. At 2408, on condition that any of the second SL transmission (1) is received using the first beam direction, (2) is associated with the first SL resource, and/or (3) includes information indicating the second SL transmission includes a first type of SCI (e.g., primary SCI from another WTRU 102), the WTRU 102 may send the first SL transmission using the first SL resource as described herein. For example, the sending of the first SL transmission sent at 2308 may include to (A) send, using the first beam direction, the first type of SCI and data of the first SL transmission using the first SL resource, and (B) send, using the second beam direction, the second type of SCI of the first SL transmission using the first SL resource.

FIG. 25 is a diagram illustrating another representative example of a communication procedure using first and second types of SCI. The procedure of FIG. 25 may be implemented by a WTRU 102 which includes a processor 118 and a transceiver 120. For example, a first type of SCI may be primary SCI and/or a second type of SCI may be paired SCI. At 2502 in FIG. 25, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2504, the WTRU 102 may determine a first beam direction (e.g., first antenna panel, first beam, and/or first direction) associated with a first SL transmission. For example, the first beam direction may be associated with a primary direction of the first SL transmission. After 2504, the WTRU 102 may monitor for a second SL transmission using the first beam direction and using a second beam direction which is different than the first beam direction at 2506. For example, the second beam direction may be associated with a paired direction of the first SL transmission. At 2408, on condition that any of the second SL transmission (1) is received using the second beam direction, (2) is associated with the first SL resource, and/or (3) includes information indicating the second SL transmission includes a second type of SCI (e.g., paired SCI from another WTRU 102), the WTRU 102 may send the first SL transmission using the first SL resource as described herein.

For example, the sending of the first SL transmission sent at 2308 may include to (A) send, using the first beam direction, the first type of SCI and data of the first SL transmission using the first SL resource, and (B) send, using the second beam direction, the second type of SCI of the first SL transmission using the first SL resource.

For example, in certain representative embodiments, such as in FIGS. 24 and/or 25, the first beam direction may associated with a first direction and/or a first beam, and/or the second beam direction may be associated with a second direction (e.g., opposite the first direction) and/or a second beam (e.g., opposite the first beam). As an example, a first antenna panel may be located on a first side of the WTRU 102 and a second antenna panel may be located on a second side of the WTRU 102.

For example, in certain representative embodiments, such as in FIGS. 24 and/or 25, the monitoring for the second SL transmission using the first beam direction and using the second beam direction may include receiving (e.g., from another WTRU 102) the second SL transmission using the first SL resource (e.g., from the first or second panel).

For example, in certain representative embodiments, such as in FIGS. 24 and/or 25, the (e.g., first and/or second type) SCI of the second SL transmission may include information indicating a resource reservation (e.g., of the first or second SL resource). For example, the (e.g., first and/or second type) SCI of the first SL transmission may include information indicating a resource reservation (e.g., of the first or second SL resource).

For example, in certain representative embodiments, such as in FIGS. 24 and/or 25, the sending, using the first beam direction, of the first type of SCI of the first SL transmission using the first SL resource may be during one or more first symbols (e.g., of a transmission time interval (TTI). For example, the sending, using the second beam direction, of the second type of SCI of the first SL transmission using the first SL resource may be (e.g., also) during one or more second symbols, which may be different than the one or more first symbols, of the same TTI (e.g., slot).

For example, in certain representative embodiments, such as in FIGS. 24 and/or 25, the first type of SCI of the first SL transmission may include one or more bits distinguishing the first type of SCI of the first SL transmission from the second type of SCI of the first SL transmission.

For example, in certain representative embodiments, such as in FIGS. 24 and/or 25, the second type of SCI of the first SL transmission may include one or more bits distinguishing the second type of SCI of the first SL transmission from the first type of SCI of the first SL transmission.

For example, in certain representative embodiments, such as in FIGS. 24 and/or 25, the sending, using the first beam direction, the first type of SCI and data of the first SL transmission using the first SL resource may include the WTRU 102 sending, using the first beam direction, a (e.g., first) DM-RS sequence which is associated with (e.g., identifies) the first type of SCI.

For example, in certain representative embodiments, such as in FIGS. 24 and/or 25, the sending, using the second beam direction, the second type of SCI of the first SL transmission using the first SL resource may include the WTRU 102 sending, using the second beam direction, a (e.g., second) DM-RS sequence which is associated with (e.g., identifies) the second type of SCI.

For example, in certain representative embodiments, such as in FIGS. 24 and/or 25, the first type of SCI of the first SL transmission may be scrambled (e.g., prior to transmission) using a first scrambling sequence associated with (e.g., identifying) the first type of SCI and/or the second type of SCI of the first SL transmission may be scrambled using a second scrambling sequence associated with (e.g., identifying) the second type of SCI.

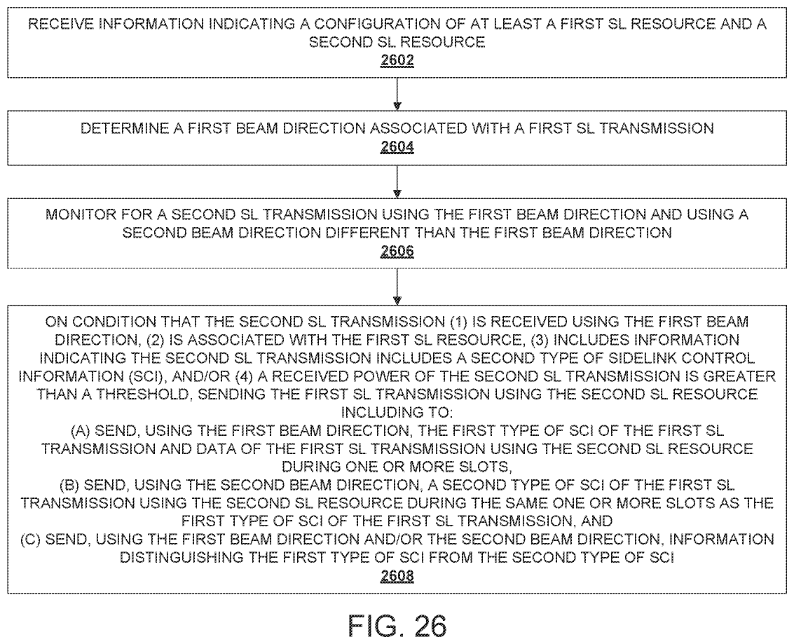

FIG. 26 is a diagram illustrating another representative example of a communication procedure using first and second types of SCI. The procedure of FIG. 26 may be implemented by a WTRU 102 which includes a processor 118 and a transceiver 120. For example, a first type of SCI may be primary SCI and/or a second type of SCI may be paired SCI. At 2602 in FIG. 26, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2604, the WTRU 102 may determine a first beam direction (e.g., first antenna panel, first beam, and/or first direction) associated with a first SL transmission. For example, the first beam direction may be associated with a primary direction of the first SL transmission. After 2604, the WTRU 102 may monitor for a second SL transmission using the first beam direction and using a second beam direction which is different than the first beam direction at 2606. For example, the second beam direction may be associated with a paired direction of the first SL transmission. At 2608, on condition that the second SL transmission (1) is received using the first beam direction, (2) is associated with the first SL resource, (3) includes information indicating the second SL transmission includes a second type of SCI (e.g., paired SCI from another WTRU 102), and/or (4) a received power of the second SL transmission is greater than a (e.g., first) threshold, the WTRU 102 may send the first SL transmission using the second SL resource as described herein. For example, the sending of the first SL transmission sent at 2608 may include to (A) send, using the first beam direction, the first type of SCI and data of the first SL transmission using the second SL resource during one or more symbols, (B) send, using the second beam direction, the second type of SCI of the first SL transmission using the second SL resource during the same one or more symbols (e.g., as the first type of SCI of the first SL transmission), and/or (C) sending, using the first beam direction and/or the second beam direction, information distinguishing the first type of SCI from the second type of SCI.

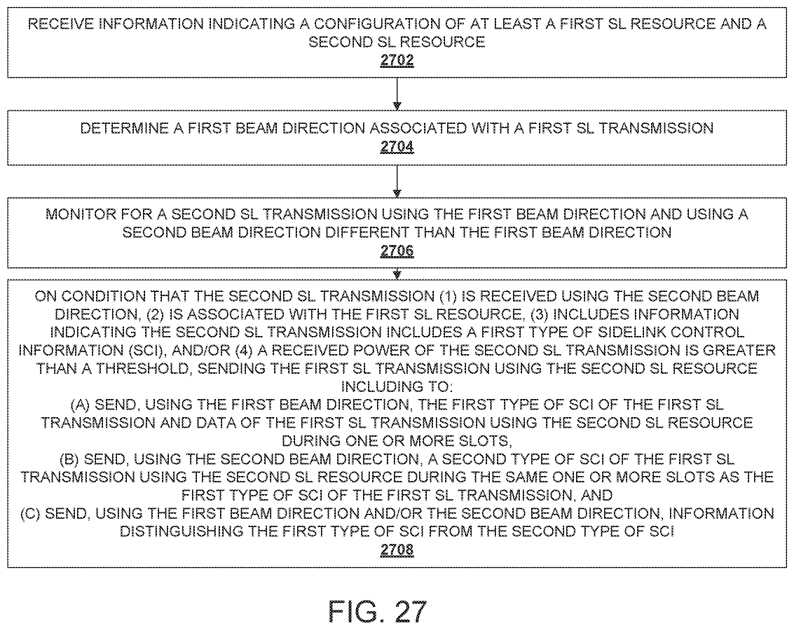

FIG. 27 is a diagram illustrating another representative example of a communication procedure using first and second types of SCI. The procedure of FIG. 27 may be implemented by a WTRU 102 which includes a processor 118 and a transceiver 120. For example, a first type of SCI may be primary SCI and/or a second type of SCI may be paired SCI. At 2702 in FIG. 27, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2704, the WTRU 102 may determine a first beam direction (e.g., first antenna panel, first beam, and/or first direction) associated with a first SL transmission. For example, the first beam direction may be associated with a primary direction of the first SL transmission. After 2704, the WTRU 102 may monitor for a second SL transmission using the first beam direction and using a second beam direction which is different than the first beam direction at 2706. For example, the second beam direction may be associated with a paired direction of the first SL transmission. At 2708, on condition that the second SL transmission (1) is received using the second beam direction, (2) is associated with the first SL resource, (3) includes information indicating the second SL transmission includes a first type of SCI (e.g., primary SCI from another WTRU 102), and/or (4) a received power of the second SL transmission is greater than a threshold, sending the first SL transmission using the second SL resource. For example, the sending of the first SL transmission sent at 2608 may include to (A) send, using the first beam direction, the first type of SCI and data of the first SL transmission using the second SL resource during one or more symbols, (B) send, using the second beam direction, the second type of SCI of the first SL transmission using the second SL resource during the same one or more symbols (e.g., as the first type of SCI of the first SL transmission), and/or (C) sending, using the first beam direction and/or the second beam direction, information distinguishing the first type of SCI from the second type of SCI.

For example, in certain representative embodiments, such as in FIGS. 26 and/or 27, the information distinguishing the first type of SCI from the second type of SCI may be sent using (e.g., only) the first beam direction and using the second SL resource during the one or more symbols.

For example, in certain representative embodiments, such as in FIGS. 26 and/or 27, the information distinguishing the first type of SCI from the second type of SCI may include one or more bits identifying the first type of SCI. As an example, the one or more bits may be included in the first type of SCI of the first SL transmission.

For example, in certain representative embodiments, such as in FIGS. 26 and/or 27, the information distinguishing the first type of SCI from the second type of SCI is sent using (e.g., only) the second beam direction and using the second SL resource during the one or more symbols. As an example, the information distinguishing the first type of SCI from the second type of SCI may include one or more bits identifying the second type of SCI. The one or more bits may be included in the second type of SCI of the first SL transmission.

For example, in certain representative embodiments, such as in FIGS. 26 and/or 27, the information distinguishing the first type of SCI from the second type of SCI may include a first DM-RS sequence which is associated with the first type of SCI. The first DM-RS sequence may be sent using (e.g., only) the first beam direction.

For example, in certain representative embodiments, such as in FIGS. 26 and/or 27, the information distinguishing the first type of SCI from the second type of SCI includes a second DM-RS sequence which is associated with the second type of SCI. The second DM-RS sequence may be sent using (e.g., only) the second beam direction.

For example, in certain representative embodiments, such as in FIGS. 26 and/or 27, the information distinguishing the first type of SCI from the second type of SCI may include the first type of SCI of the first SL transmission being scrambled (e.g., prior to transmission) using a first scrambling sequence associated with (e.g., identifying) the first type of SCI.

For example, in certain representative embodiments, such as in FIGS. 26 and/or 27, the information distinguishing the first type of SCI from the second type of SCI may include the second type of SCI of the first SL transmission being scrambled using a second scrambling sequence associated with (e.g., identifying) the second type of SCI.

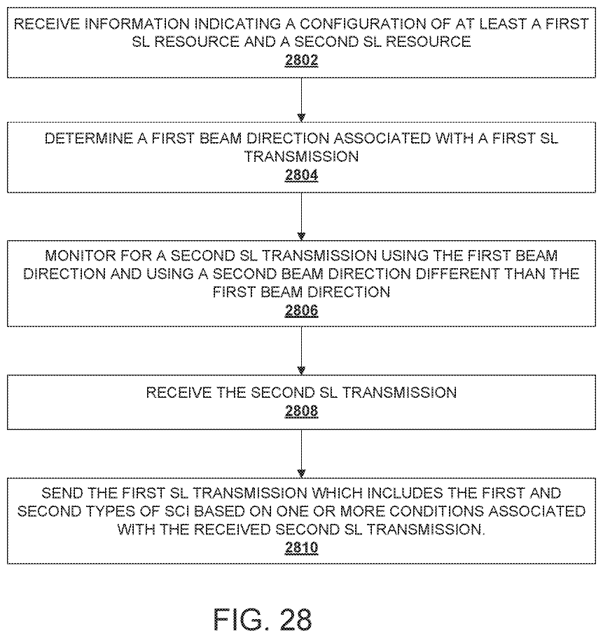

FIG. 28 is a diagram illustrating another representative example of a communication procedure using first and second types of SCI. The procedure of FIG. 28 may be implemented by a WTRU 102 which includes a processor 118 and a transceiver 120. For example, a first type of SCI may be primary SCI and/or a second type of SCI may be paired SCI. At 2802 in FIG. 28, the WTRU 102 may receive information indicating a configuration of at least a first SL resource and a second SL resource. For example, the first SL resource may be a first set of frequency resources which are configured for SL communication and the second SL resource may be a second set of frequency resources which are configured for SL communication. At 2804, the WTRU 102 may determine a first beam direction (e.g., first antenna panel, first beam, and/or first direction) associated with a first SL transmission. For example, the first beam direction may be associated with a primary direction of the first SL transmission. After 2804, the WTRU 102 may monitor for a second SL transmission (e.g., from another WTRU 102) using the first beam direction and using a second beam direction which is different than the first beam direction at 2806. For example, the second beam direction may be associated with a paired direction of the first SL transmission. At 2808, the WTRU 102 may receive the second SL transmission. At 2810, the WTRU 102 may send (e.g., using the first and second beam directions) the first SL transmission (e.g., to another WTRU 102) which includes the first and second types of SCI. For example, the first SL transmission may be sent based on one or more conditions associated with the received second SL transmission as described herein.

As examples, the sending of the first SL transmission at 2810 may be performed using any of the procedures shown in FIGS. 22-27 or a combination and/or modification thereof. In one example, the first SCI and second SCI may be transmitted according to a configured slot structure where the first SCI is sent in a first set of symbols and the second SCI is sent in a second set of symbols of a given TTI. In another example, the first SCI and second SCI may be transmitted according to a configured slot structure where the first SCI and the second SCI are transmitted in a same set of symbols (e.g., of a same slot).

In certain representative embodiments, a WTRU 102 may include a processor 118 and a transceiver 120 which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the first direction, (2) is associated with the first SL resource, and/or (3) includes SL control information (SCI) indicating the SCI of the second SL transmission is primary SCI, the WTRU 102 may send the first SL transmission using the first SL resource. The sending of the first SL transmission using the first SL resource may include (1) sending, in the first direction, primary SCI and data of the first SL transmission using the first SL resource, and (2) sending, in the second direction, paired SCI of the first SL transmission using the first SL resource.

In certain representative embodiments, a WTRU 102 may include a processor and a transceiver which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the second direction, (2) is associated with the first SL resource, and/or (3) includes SL control information (SCI) indicating the SCI of the second SL transmission is paired SCI, the WTRU 102 may send the first SL transmission using the first SL resource. The sending of the first SL transmission using the first SL resource may include (1) sending, in the first direction, primary SCI and data of the first SL transmission using the first SL resource, and (2) sending, in the second direction, paired SCI of the first SL transmission using the first SL resource.

In certain representative embodiments, a WTRU 102 may include a processor and a transceiver which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the second direction, (2) is associated with the first SL resource, (3) includes SL control information (SCI) indicating the SCI of the second SL transmission is primary SCI, and/or (4) a received power of the second SL transmission is less than or equal to a threshold, the WTRU 102 may send the first SL transmission using the first SL resource. The sending of the first SL transmission using the first SL resource may include: (1) sending, in the first direction, primary SCI and data of the first SL transmission using the first SL resource, and (2) sending, in the second direction, paired SCI of the first SL transmission using the first SL resource.

In certain representative embodiments, a WTRU 102 may include a processor and a transceiver which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the second direction, (2) is associated with the first SL resource, (3) includes SL control information (SCI) indicating the SCI of the second SL transmission is primary SCI, and/or (4) a received power of the second SL transmission is greater than a threshold, the WTRU 102 may send the first SL transmission using the second SL resource. The sending of the first SL transmission using the second SL resource may include: (1) sending, in the first direction, primary SCI and data of the first SL transmission using the second SL resource, and (2) sending, in the second direction, paired SCI of the first SL transmission using the second SL resource.

In certain representative embodiments, a WTRU 102 may include a processor and a transceiver which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the first direction, (2) is associated with the first SL resource, (3) includes SL control information (SCI) indicating the SCI of the second SL transmission is paired SCI, and/or (4) a received power of the second SL transmission is less than or equal to a threshold, the WTRU 102 may send the first SL transmission using the first SL resource. The sending of the first SL transmission using the first SL resource may include: (1) sending, in the first direction, primary SCI and data of the first SL transmission using the first SL resource, and (2) sending, in the second direction, paired SCI of the first SL transmission using the first SL resource.

In certain representative embodiments, a WTRU 102 may include a processor and a transceiver which are configured to implement a method which includes the WTRU 102 receiving information indicating a configuration of at least a first SL resource. The WTRU 102 may determine a first direction (e.g., corresponding to a first beam and/or antenna panel) associated with a first SL transmission. The WTRU 102 may monitor for a second SL transmission in the first direction and a second direction different than the first direction (e.g., corresponding to a first beam and/or antenna panel). On condition that (1) the second SL transmission is received from the first direction, (2) is associated with the first SL resource, (3) includes SL control information (SCI) indicating the SCI of the second SL transmission is paired SCI, and/or (4) a received power of the second SL transmission is greater than a threshold, the WTRU 102 may send the first SL transmission using the second SL resource. The sending of the first SL transmission using the second SL resource may include: (1) sending, in the first direction, primary SCI and data of the first SL transmission using the second SL resource, and (2) sending, in the second direction, paired SCI of the first SL transmission using the second SL resource.

In certain representative embodiments, the monitoring for the second SL transmission in the first direction and the second direction may include receiving the second SL transmission in the first direction, or the second direction, using the first SL resource.

In certain representative embodiments, the SCI of the second SL transmission may include information indicating a reservation of the first SL resource. For example, the reservation of the first SL resource may be for a slot including a plurality of symbols.

In certain representative embodiments, the primary SCI of the first SL transmission may be sent in a slot before the paired SCI of the first SL transmission is sent in the same slot.

In certain representative embodiments, the primary SCI of the first SL transmission may be sent in a slot after the paired SCI of the first SL transmission is sent in the same slot.

In certain representative embodiments, the primary SCI of the first SL transmission and the paired SCI of the first SL transmission may be sent in a same one or more symbols in a same slot.

In certain representative embodiments, the first SL transmission may be associated with a second WTRU and the second SL transmission is associated with a third WTRU.

In certain representative embodiments, the second direction may be substantially opposite to the first direction.

In certain representative embodiments, a WTRU 102 may include a processor and a transceiver which are configured to implement a method which includes the WTRU 102 receiving information indicating a configuration of a set of sidelink (SL) resources. The WTRU 102 may decode one or more SL control information (SCI) received over the set of SL resources in a first direction associated with a target SL device and/or a second direction associated with the first direction. The WTRU 102 may select a SL resource from among the set of SL resources using the decoded one or more SCI. The WTRU 102 may send, in the first direction, primary SCI and data for the target SL device using the selected SL resource. The WTRU 102 may send, in the second direction, paired SCI using the selected SL resource.

In certain representative embodiments, the primary SCI, the paired SCI and the data for the target SL device may comprise a SL transmission in a SL slot.

In certain representative embodiments, a multiplexing pattern of the SL transmission in the SL slot is in the order of the primary SCI, the paired SCI, and the data for the target SL device.

In certain representative embodiments, a multiplexing pattern of the SL transmission in the SL slot is in the order of the paired SCI, the primary SCI, and the data for the target SL device.

In certain representative embodiments, a multiplexing pattern of the SL transmission in the SL slot is in the order of the primary SCI, the data for the target SL device, and the paired SCI.

In certain representative embodiments, the primary SCI may be sent in the first direction during one or more same symbols of a SL slot, and the paired SCI may be sent in the second direction during one or more same symbols of the same SL slot.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented in a wireless transmit/receive apparatus (WTRU) to communicate a first type of sidelink (SL) control information (SCI) and a second type of SCI, the method comprising:
receiving information indicating a configuration of at least a first SL resource and a second SL resource;
determining a first beam direction associated with a first SL transmission;
monitoring for a second SL transmission using the first beam direction and using a second beam direction different than the first beam direction; and
on condition that the second SL transmission (1) is received using the second beam direction, (2) is associated with the first SL resource, (3) includes information indicating the second SL transmission includes the first type of SCI, and/or (4) a received power of the second SL transmission is greater than a threshold, sending the first SL transmission using the second SL resource,
wherein the sending of the first SL transmission using the second SL resource includes:
sending, using the first beam direction, the first type of SCI and data of the first SL transmission using the second SL resource, and
sending, using the second beam direction, the second type of SCI of the first SL transmission using the second SL resource.

2. (canceled)

3. (canceled)

4. The method of claim 1, wherein the first beam direction is associated with a first direction and the second beam direction is associated with a second direction opposite the first direction, and wherein the monitoring for the second SL transmission using the first beam direction and using the second beam direction includes receiving the second SL transmission using the first SL resource.

5. (canceled)

6. The method of claim 1, wherein the first type of SCI of the second SL transmission includes information indicating a reservation of the first SL resource.

7. The method of claim 1, wherein the sending, using the first beam direction, of the first type of SCI of the first SL transmission using the second SL resource is during one or more first symbols of a transmission time interval (TTI), and
wherein the sending, using the second beam direction, of the second type of SCI of the first SL transmission using the second SL resource is during one or more second symbols, different than the one or more first symbols, of the same-TTI.

8. The method of claim 1, wherein any of one or more bits, a scrambling sequence, and/or a demodulation reference signal (DMRS) sequence distinguishes the first type of SCI from the second type of SCI.

9. (canceled)

10. (canceled)

11. (canceled)

12. (canceled)

13. A wireless transmit/receive apparatus (WTRU) to communicate a first type of sidelink (SL) control information (SCI) and a second type of SCI, the WTRU comprising:
a processor, memory, and a transceiver which are configured to:
receive information indicating a configuration of at least a first SL resource and a second SL resource,
determine a first beam direction associated with a first SL transmission,
monitor for a second SL transmission using the first beam direction and using a second beam direction different than the first beam direction, and
on condition that the second SL transmission (1) is received using the second beam direction, (2) is associated with the first SL resource, (3) includes information indicating the second SL transmission includes the first type of SCI, and/or (4) a received power of the second SL transmission is greater than a threshold, send the first SL transmission using the second SL resource which includes to:
send, using the first beam direction, the first type of SCI and data of the first SL transmission using the second SL resource, and
send, using the second beam direction, the second type of SCI of the first SL transmission using the second SL resource.

14. (canceled)

15. (canceled)

16. The WTRU of claim 13, wherein the first beam direction is associated with a first direction and the second beam direction is associated with a second direction opposite the first direction, and wherein the processor and the transceiver are configured to monitor for the second SL transmission using the first beam direction and using the second beam direction including to receive the second SL transmission using the first SL resource.

17. (canceled)

18. The WTRU of claim 13, wherein the first type of SCI of the second SL transmission includes information indicating a reservation of the first SL resource.

19. The WTRU of claim 13, wherein the first type of SCI of the first SL transmission is sent using the second SL resource during one or more first symbols of a transmission time interval (TTI), and
wherein the second type of SCI of the first SL transmission is sent using the second SL resource during one or more second symbols, different than the one or more first symbols, of the TTI.

20. The WTRU of claim 13, wherein any of one or more bits, a scrambling sequence, and/or a demodulation reference signal (DMRS) sequence distinguishes the first type of SCI from the second type of SCI.

21. (canceled)

22. (canceled)

23. (canceled)

24. (canceled)

25. A method implemented in a wireless transmit/receive apparatus (WTRU) to communicate a first type of sidelink (SL) control information (SCI) and a second type of SCI, the method comprising:
receiving information indicating a configuration of at least a first SL resource and a second SL resource;
determining a first beam direction associated with a first SL transmission;
monitoring for a second SL transmission using the first beam direction and using a second beam direction different than the first beam direction; and
on condition that the second SL transmission (1) is received using the first beam direction, (2) is associated with the first SL resource, (3) includes information indicating the second SL transmission includes the second type of SCI, and/or (4) a received power of the second SL transmission is greater than a threshold, sending the first SL transmission using the second SL resource,
wherein the sending of the first SL transmission using the second SL resource includes:
sending, using the first beam direction, the first type of SCI and data of the first SL transmission using the second SL resource, and
sending, using the second beam direction, the second type of SCI of the first SL transmission using the second SL resource.

26. The method of claim 25, wherein the first beam direction is associated with a first direction and the second beam direction is associated with a second direction opposite the first direction, and wherein the monitoring for the second SL transmission using the first beam direction and using the second beam direction includes receiving the second SL transmission using the first SL resource.

27. The method of claim 25, wherein the first type of SCI of the second SL transmission includes information indicating a reservation of the first SL resource.

28. The method of claim 25, wherein the sending, using the first beam direction, of the first type of SCI of the first SL transmission using the second SL resource is during one or more first symbols of a transmission time interval (TTI), and
wherein the sending, using the second beam direction, of the second type of SCI of the first SL transmission using the second SL resource is during one or more second symbols, different than the one or more first symbols, of the TTI.

29. The method of claim 25, wherein any of one or more bits, a scrambling sequence, and/or a demodulation reference signal (DMRS) sequence distinguishes the first type of SCI from the second type of SCI.

30. A wireless transmit/receive apparatus (WTRU) to communicate a first type of sidelink (SL) control information (SCI) and a second type of SCI, the WTRU comprising:
a processor, memory, and a transceiver which are configured to:
receive information indicating a configuration of at least a first SL resource and a second SL resource,
determine a first beam direction associated with a first SL transmission,
monitor for a second SL transmission using the first beam direction and using a second beam direction different than the first beam direction, and
on condition that the second SL transmission (1) is received using the first beam direction, (2) is associated with the first SL resource, (3) includes information indicating the second SL transmission includes the second type of SCI, and/or (4) a received power of the second SL transmission is greater than a threshold, send the first SL transmission using the second SL resource which includes to:
send, using the first beam direction, the first type of SCI and data of the first SL transmission using the second SL resource, and
send, using the second beam direction, the second type of SCI of the first SL transmission using the second SL resource.

31. The WTRU of claim 30, wherein the first beam direction is associated with a first direction and the second beam direction is associated with a second direction opposite the first direction, and wherein the processor and the transceiver are configured to monitor for the second SL transmission using the first beam direction and using the second beam direction including to receive the second SL transmission using the first SL resource.

32. The WTRU of claim 30, wherein the first type of SCI of the second SL transmission includes information indicating a reservation of the first SL resource.

33. The WTRU of claim 30, wherein the first type of SCI of the first SL transmission is sent using the second SL resource during one or more first symbols of a transmission time interval (TTI), and
wherein the second type of SCI of the first SL transmission is sent using the second SL resource during one or more second symbols, different than the one or more first symbols, of the TTI.

34. The WTRU of claim 30, wherein any of one or more bits, a scrambling sequence, and/or a demodulation reference signal (DMRS) sequence distinguishes the first type of SCI from the second type of SCI.
